(19) United States
(12) Patent Application Publication
(10) Pub. No.: US 2025/0209552 A1
(43) Pub. Date: Jun. 26, 2025

(54) AUTOMATED DETECTION AND NOTIFICATION OF UNPERFORMED AUTOMATED LEASING EVENTS

(71) Applicant: Invitation Homes Inc., Dallas, TX (US)

(72) Inventor: John Allen Mathews, Carrollton, TX (US)

(21) Appl. No.: 18/990,924

(22) Filed: Dec. 20, 2024

Related U.S. Application Data
(60) Provisional application No. 63/614,341, filed on Dec. 22, 2023.

(51) Int. Cl. G06Q 50/16; G06Q 30/0601; G06Q 30/0645

(52) U.S. Cl. CPC G06Q 50/16; G06Q 30/0617; G06Q 30/0645

(57) ABSTRACT

An automated system for detecting and notifying of unperformed automated leasing events includes processor(s) are configured to feed source data to a machine learning algorithm. The source data includes data points for leasing event metric values recorded with corresponding timestamps. The processor(s) are configured to obtain confidence data from the machine learning algorithm. The confidence data includes an upper or lower confidence interval values for the corresponding timestamps. The processor(s) are configured to identify a trigger index and a corresponding trigger timestamp from the source data, identify a trigger interval value from the upper or lower confidence interval values that corresponds with the trigger timestamp, detect an anomaly indicative of unperformed leasing event(s) in response to determining that the trigger index extends beyond the trigger interval value at the trigger timestamp, and generate and transmit an alert for remediation in response to detecting the unperformed leasing event(s).

### CROSS-REFERENCE TO RELATED APPLICATION

This application claims the benefit of U.S. Patent Application Ser. No. 63/614,341, filed on Dec. 22, 2023, which is incorporated herein by reference in its entirety.

### TECHNICAL FIELD

The present disclosure generally relates to property management systems and, more specifically, to automated detection and notification of unperformed automated leasing events.

### BACKGROUND

Real estate can be a fast-paced industry. There are a number of tasks (e.g., lease submissions, mailing of lease renewals, financial payments, etc.) that need to be performed quickly and in a timely manner. Recently, some parties within the real estate industry, such as leasing agencies, have begun to implement automated systems to perform some of these functions in an automated manner. Additionally, monitoring and/or observability systems have been used to track the performance of such functions by the automated systems.

Monitoring and observability systems are being used more and more within various industries. Monitoring and observability systems may incorporate techniques, such as logging and/or tracing techniques, to collect data indicative of one or more monitored events, such as the performance of automated functions. Additionally, monitoring and observability systems may analyze the collected data to identify trends with the automated functions.

In some instances, an error may occur with the performance of one or more automated tasks. While monitoring and observability systems make it easy to identify when the automated systems do perform the designated tasks in an automated manner, it can still difficult to detect tasks when tasks that should have occurred did not actually occur, for example, due to an error with the corresponding automated system(s). That is, it can be difficult to detect the absence of an event, especially if such an event is subject to seasonal (e.g., daily, weekly, monthly, etc.) fluctuations.

### SUMMARY

Example embodiments are disclosed for automated detection and notification of unperformed leasing events. The present document discloses aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example automated system for detecting and notifying of unperformed automated leasing events includes memory configured to store instructions and one or more processors configured to execute the instructions. The one or more processors are configured to feed source data to a machine learning algorithm. The source data includes data points for leasing event metric values recorded with corresponding timestamps. The one or more processors are configured to obtain confidence data from the machine learning algorithm. The confidence data includes upper or lower confidence interval values for the corresponding timestamps. The upper or lower confidence interval values are indicative of upper or lower bounds of expected quantities of leasing events recorded with the corresponding timestamps. The one or more processors are configured to identify a trigger index and a corresponding trigger timestamp from the source data, identify a trigger interval value from the upper or lower confidence interval values that corresponds with the trigger timestamp, detect an anomaly indicative of one or more unperformed leasing events in response to determining that the trigger index extends beyond the trigger interval value at the trigger timestamp, and generate and transmit an alert for remediation in response to detecting the unperformed leasing event.

An example automated system for detecting and notifying of non-performance of customer-requested executions on a mobile app for rental property shopping is disclosed. The automated system includes memory configured to store instructions and one or more processors configured to execute the instructions. The one or more processors are configured to feed source data to a machine learning algorithm. The source data includes data points for recorded quantities of the customer-requested executions at corresponding timestamps. The one or more processors are configured to obtain confidence data from the machine learning algorithm. The confidence data includes lower confidence interval values for the corresponding timestamps. The lower confidence interval values are indicative of lower bounds of expected quantities of the customer-requested executions on the mobile app at the corresponding timestamps. The one or more processors are configured to identify a trigger index and a corresponding trigger timestamp from the source data, identify a trigger interval value from the lower confidence interval values that corresponds with the trigger timestamp, detect an anomaly indicative of one or more unperformed customer-requested executions in response to determining that the trigger index is less than the trigger interval value at the trigger timestamp, and generate and transmit an alert for remediation in response to detecting the one or more unperformed customer-requested executions.

An example automated system for detecting and notifying of non-performance of artificial intelligence (AI) chatbot messages that are programmed to be sent automatically in response to receiving inquiries from customers shopping for rental properties is disclosed. The automated system includes memory configured to store instructions and one or more processors configured to execute the instructions. The one or more processors are configured to feed source data to a machine learning algorithm. The source data includes data points for recorded quantities of the AI chatbot messages sent at corresponding timestamps. The one or more processors are configured to obtain confidence data from the machine learning algorithm. The confidence data includes lower confidence interval values for the corresponding timestamps. The lower confidence interval values are indicative of lower bounds of expected quantities of the AI chatbot messages at the corresponding timestamps. The one or more processors are configured to identify a trigger index and a corresponding trigger timestamp from the source data, identify a trigger interval value from the lower confidence interval values that corresponds with the trigger timestamp, detect an anomaly indicative of one or more unperformed chatbot messages in response to determining that the trigger index is less than the trigger interval value at the trigger timestamp, and generate and transmit an alert for remediation in response to detecting the one or more unperformed chatbot messages.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which a detection system automatically detects and notifies a property management system of unperformed leasing events in accordance with the teachings herein.

FIG. 2 is a block diagram of the detection system of FIG. 1.

FIG. 3 depicts a sequence of operation in which the detection system of FIG. 1 detects and notifies a property management system of unperformed leasing events.

FIGS. 4A-4B depict an example flowchart for automatically detecting and notifying a property management system of unperformed leasing events in accordance with the teachings herein.

FIG. 5 is an example graph generated by the detection system of FIG. 1 for monitoring synchronization of rent prices.

FIG. 6 is an example graph generated by the detection system of FIG. 1 for monitoring the transmission of lease submissions.

FIG. 7 is an example graph generated by the detection system of FIG. 1 for monitoring the transmission of lease renewal communications.

FIG. 8 is an example graph generated by the detection system of FIG. 1 for monitoring the quantity of file transfers with external systems.

FIG. 9 is an example graph generated by the detection system of FIG. 1 for monitoring the quantity of errors detected during lease payment processes.

FIG. 10 is an example graph generated by the detection system of FIG. 1 for monitoring the quantity of financial payments.

FIG. 11 is an example graph generated by the detection system of FIG. 1 for monitoring the quantity of tasks performed for a financial database system.

FIG. 12 is an example graph generated by the detection system of FIG. 1 for monitoring the quantity of customer-requested executions performed on a mobile app.

FIG. 13 is an example graph generated by the detection system of FIG. 1 for monitoring the quantity of artificial intelligence (AI) chatbot responses sent to customers.

FIG. 14 is an example graph generated by the detection system of FIG. 1 for monitoring the quantity of successful customer authentication executions.

FIG. 15 is an example graph generated by the detection system of FIG. 1 for monitoring durations of time to execute multi-system rental processes.

FIGS. 16A-16D depict example seasonal patterns of leasing events.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example detection systems and methods disclosed herein automatically detect and notify one or more interested parties when an event that is associated with a monitored metric, such as a leasing event, recently has not been performed. As used herein, a “detection system” refers to a system configured to detect an unperformed event, such as a leasing event, that should have otherwise been performed by an automated system. As used herein, an “unperformed event” refers to an event that (1) is not identified in source data (e.g., of a monitoring system) as having been performed but (2) were expected to have been performed (e.g., by the detection system) based on analysis of other source data.

To detect unperformed events, example detection systems and methods may retrieve raw source data associated with a monitored metric from monitoring system(s), reformat the raw source data for a machine learning system, feed the reformatted source data associated with the monitored metric to the machine learning system as an input, collect confidence data associated with the monitored metric as an output of the machine learning system, identify a trigger index within the source data, and compare the trigger index to corresponding confidence data.

That is, to detect a recent event that was not performed by an automated system, a detection system collects source data that includes values of metrics indicative of when events of interest have recently occurred. The detection system preprocesses the collected source data to reformat the data into a format usable by a machine learning algorithm. Further, the detection system sets configurations of the machine learning algorithm to enable the machine algorithm to generate meaningful outputs for the monitored metric, feeds the reformatted source data to the machine learning algorithm, and collects output data from the machine learning algorithm in the form of confidence data. The confidence data collected by the detection system is indicative of how likely an event of interest is to have occurred at recent time periods and takes into account seasonal fluctuations (e.g., daily, weekly, monthly, etc.) that occur with the monitored metric. The detection system then identifies a trigger index from an entry within the source data, a timestamp corresponding to the trigger index, and confidence data corresponding to the identified timestamp. The detection system determines whether an anomaly indicative of unperformed event(s) has been detected based on a comparison of the trigger index to one or more values types (e.g., a mean, a lower confidence interval, and/or an upper confidence interval) of the confidence data. Upon detection, the detection system automatically generates and transmits an alert signal to notify a system and/or party of interest that an unperformed event has been detected.

Thus, the examples disclosed herein include an unconventional and specific set of rules to generate new, seasonal-adjusted confidence data which, in turn, is used to accurately detect, in an automated manner and with a high degree of confidence, whether an automated event that should have been performed has not been performed. Because those rules are arranged to monitor the performance of automated tasks, the systems and methods disclosed herein are necessarily rooted in the computer technology of automated task tools. Further, the use of a machine learning algorithm to generate a confidence interval likely would not otherwise be implemented by those in search of an automated tool for monitoring whether automated tasks, such as real estate leasing events, were properly performed.

As used herein, a “monitoring system” refers to a system configured to collect data of monitored metric(s). As used herein, a “monitored metric” is a metric whose data is collected by monitoring system(s) and indicative of whether events of interest, such as leasing events, have been performed.

As used herein, “raw source data” refers to data associated with monitored metric(s) that is stored by a monitoring system in a preselected format of the monitoring system. Raw source data may be retrieved from the monitoring system by a detection system for subsequent analysis. Example raw source data may include a plurality of entries, with each entry including a value of a monitored metric and a corresponding timestamp at which event(s) associated with the monitored metric have occurred. As used herein, “reformatted source data” refers to raw source data that has been reformatted by a detection system in a format usable by a machine learning algorithm. As used herein, a “trigger index” refers to one or more values of a monitored metric of an entry in source data that is compared to confidence data (e.g., by a detection system) to determine whether a recent unperformed event has been detected.

As used herein, a “machine learning system” and an “ML system” refer to a system configured to perform and/or operate a machine learning algorithm. As used herein, “confidence data” refers to output data of a machine learning algorithm that is indicative as to how likely and/or frequently event(s) associated with monitored metric(s) is to have occurred at a particular time. Example confidence data may be collected in the form of a matric, with each column corresponding with a respective value type. Example value types of confidence data includes a timestamp, a mean value for the monitored metric at the corresponding timestamp, a lower confidence interval for the monitored metric at the corresponding timestamp, and/or an upper confidence interval for the monitored metric at the corresponding timestamp.

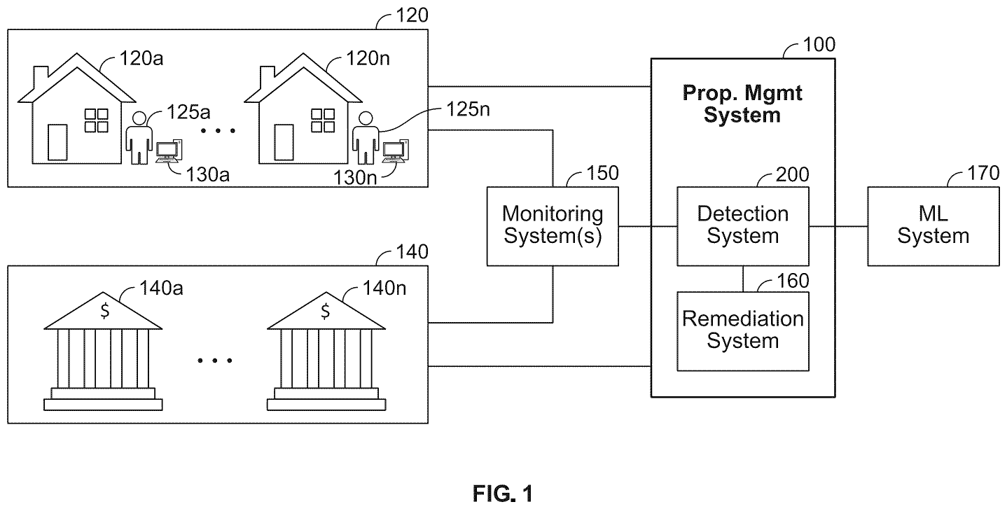

Turning to the figures, FIG. 1 illustrates an example environment in which an example detection system 200 detects unperformed events in accordance with the teachings herein. In the illustrated example, a property management system 100 includes the detection system 200 to detect unperformed leasing events. A leasing agency and/or another real estate entity uses the property management system 100 to manage one or more properties 120 and/or conduct transactions with one or more financial institutions 140, such as banks, an automated manner. The property management system 100 of the real estate entity may communicate with current and/or potential tenants 125 of the properties, for example, via computing devices 130 (e.g., desktops, laptops, smartphones, tablets, smartwatches, etc.) of the respective tenants 125.

The property management system 100 performs a large quantity of tasks associated with interactions with the properties 120, tenants 125, and/or financial institutions 140. To perform such a large quantity of tasks, the property management system 100 may implement automated system(s) to perform one or more those tasks in an automated manner. In the illustrated example, the property management system 100 utilizes one or more monitoring systems 150 to track the performance of the automated tasks. The monitoring system(s) 150 are configured to collect data indicating when the automated tasks have occurred. In some examples, the monitoring system(s) 150 include an internal monitoring system of the property management system 100, a financial monitoring system for tracking financial transactions, and/or another third-party monitoring system (e.g., a software-as-a-service system such as Salesforce®). Additionally or alternatively, the monitoring system(s) 150 may include an observability system (e.g., Datadog®) that aggregates and/or correlates raw data from other monitoring system(s) 150, such as internal monitoring system(s), financial monitoring system(s), and/or other third-party monitoring system(s).

As disclosed below in greater detail, the detection system 200 is configured to detect when automated events subject to seasonal fluctuations are not performed by the property management system 100 and notify a remediation system 160 of such occurrences for further investigation. The detection system 200 is configured to retrieve data from the monitoring system(s) 150 that have been collected to track the performance of the automated tasks. To detect unperformed event(s), the detection system 200 is configured to identify when task(s) that are expected to have occurred do not appear to have occurred based on the data collected by the monitoring system(s) 150.

Upon detecting recent unperformed event(s), the detection system 200 is configured to notify a remediation system 160 to further investigate the issue. For example, the remediation system 160 may investigate the automated systems of the property management system 100, the monitoring system(s) 150, and/or other internal and/or external system(s) (1) to confirm that automated task(s) that should have occurred have not occurred and (2) to identify and/or troubleshoot the cause of unperformed automated task(s). In the illustrated example, the property management system 100 includes the remediation system 160. In other examples, the property management system 100 may be an external system.

Some automated tasks are subject to seasonal fluctuations. For example, the tasks may be performed more or less frequently based on the time of day (also known as “daily seasonality”), the time of the week (also known as “weekly seasonality”), the time of the month (also known as “monthly seasonality”), the time of the year (also known as “yearly seasonality”), and/or the occurrence of holidays (also known as “holiday seasonality”). Such seasonal fluctuations makes it difficult to identify when automated event(s) that should have occurred have not occurred. For example, if the quantity of automated tasks that should have been performed and recorded at a particular time fluctuates based on the time of day, the day of the week, and/or the time of month, it can be difficult to detect the non-performance of such a task.

To facilitate the detection of automated events subject to seasonal fluctuations, the detection system 200 is configured to interact with a machine learning (ML) system 170. In the illustrated example, the ML system 170 is external to the detection system 200 and the property management system 100. In other examples, the ML system 170 is internal to and/or included in the detection system 200 and/or the property management system 100.

The ML system 170 is configured to use a machine learning algorithm to facilitate the detection system 200 in detecting the non-performance of automated tasks subject to seasonal fluctuations. A machine learning algorithm is a form of artificial intelligence (AI) that enables a system to automatically learn and improve from experience without being explicitly programmed by a programmer for a particular function. For example, machine learning models access data and learn from the accessed data to improve performance of a particular function. Exemplary types of machine learning models include decision trees, support vectors, clustering, Bayesian networks, sparse dictionary learning, rules-based machine learning, etc. A nonparametric regression model is an exemplary type of machine learning model in which no parametric form is assumed for the relationship between independent and dependent variables. An exemplary nonparametric regression model is an additive regression model such as Prophet, which is open source software released by Meta®. An additive regression model incorporates the arithmetic sum of the individual effects of each independent variable.

In the illustrated environment of FIG. 1, the machine learning algorithm is configured to generate output data indicative of an expected frequency of recent automated tasks based on input data indicative of a recorded frequency of recent automated tasks. To facilitate the machine learning algorithm, the detection system 200 is configured to set and/or instruct the ML system 170 to set one or more configuration settings for the machine learning algorithm.

The detection system 200 is configured to then provide data indicative of recently executed automated tasks (e.g., and collected by the monitoring system(s) 150) as an input that is fed to the machine learning algorithm. The detection system 200 is configured to subsequently collect output data from the machine learning algorithm that is indicative of the quantity of automated tasks that are expected to have recently occurred. By comparing the actual quantity of occurrences to value(s) indicative of the expected quantity of occurrences, the detection system 200 is able to detect an unperformed event.

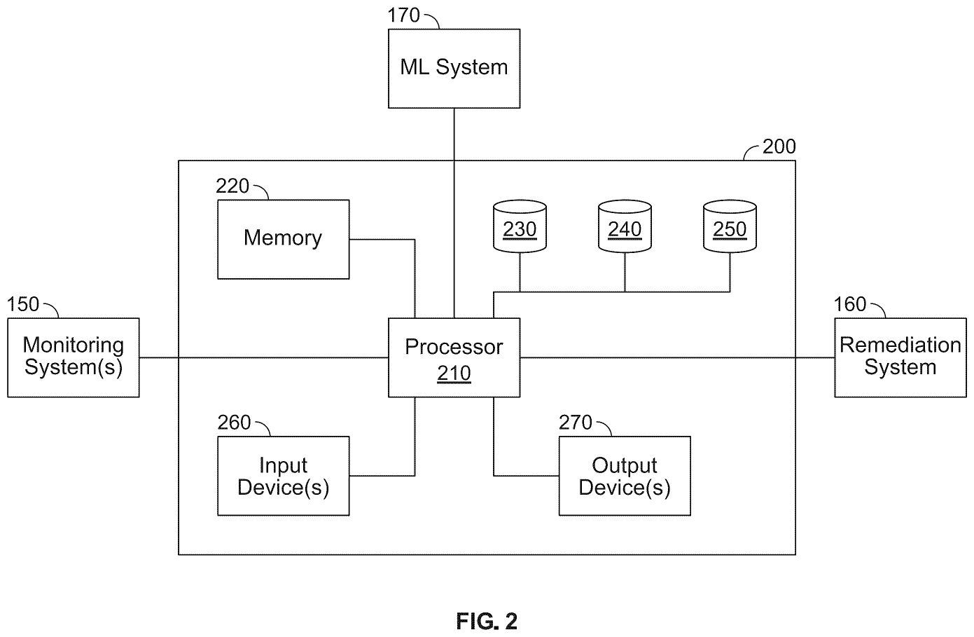

FIG. 2 depicts a block diagram of components of the detection system 200 of the property management system 100. In the illustrated example, the detection system 200 includes one or more processors 210, memory 220, a source database 230, a machine learning (ML) database 240, an assessment database 250, one or more input devices 260, and one or more output device 270.

The processor(s) 210 may be any suitable processing device or set of processing devices such as, but not limited to, a microprocessor, a microcontroller-based platform, an integrated circuit, etc. The processor(s) 210 are communicatively connected to the monitoring system(s) 150 to collect raw source data from the monitoring system(s) 150 for the source database 230. The processor(s) 210 are communicatively connected to the ML system 170 to feed reformatted source data to the ML system 170 and/or obtain confidence data from the ML system 170. The processor(s) 210 are communicatively connected to the remediation system 160 (e.g., via the monitoring system(s) 150) to transmit alert(s) associated with detection of unperformed leasing event(s).

The memory 220 may include one or more of volatile memory, non-volatile memory, read-only memory, etc. In some examples, the memory 220 may include a combination of multiple kinds of memory, such as volatile memory and non-volatile memory. The memory 220 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 220, the computer readable medium, and/or within the processor(s) 210 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The source database 230 is configured to store raw source data retrieved by the processor(s) 210 and/or reformatted source data generated by the processor(s) 210. The machine learning (ML) database 240 is configured to store confidence data and/or other output data generated by a machine learning algorithm and/or the ML system 170. Additionally, the ML database 240 is configured to store configuration settings for the machine learning algorithm. The assessment database 250 is configured to store graph(s) generated by the processor(s) 210 that depict a comparison between source data and confidence data and/or depict the detection of unperformed event(s). In the illustrated example, each of the source database 230, the ML database 240, and the assessment database 250 are separate from each other. In other examples, the source database 230, the ML database 240, and/or the assessment database 250 may be combined in the form of a single database. Additionally or alternatively, one or more of the source database 230, the ML database 240, and/or the assessment database 250 may collectively be formed by a plurality of different databases.

The input device(s) 260 enable an operator, such as an information technician or analyst of the detection system 200, to provide instructions, commands, and/or data to the processor(s) 210. Additionally or alternatively, the input device(s) 260 enable the operator to modify and/or update the instructions stored in the memory 220 and/or data stored in the source database 230, the ML database 240, and/or the assessment database 250. Example input device(s) 260 include a keyboard, a mouse, a touch screen, a touchpad, a speech recognition system, an instrument panel, button(s), control knob(s), etc.

The output device(s) 270 display output information and/or data of the detection system 200 to an operator, such as an information technician or analyst. Example output device(s) 270 include a liquid crystal display (LCD), an organic light emitting diode (OLED) display, a flat panel display, a solid state display, and/or any other device that visually presents information to the operator. Additionally or alternatively, the output device(s) 270 may include one or more speakers and/or any other device(s) that provide audio output signals for the operator. Further, the output device(s) 270 may provide other types of output information, such as haptic signals.

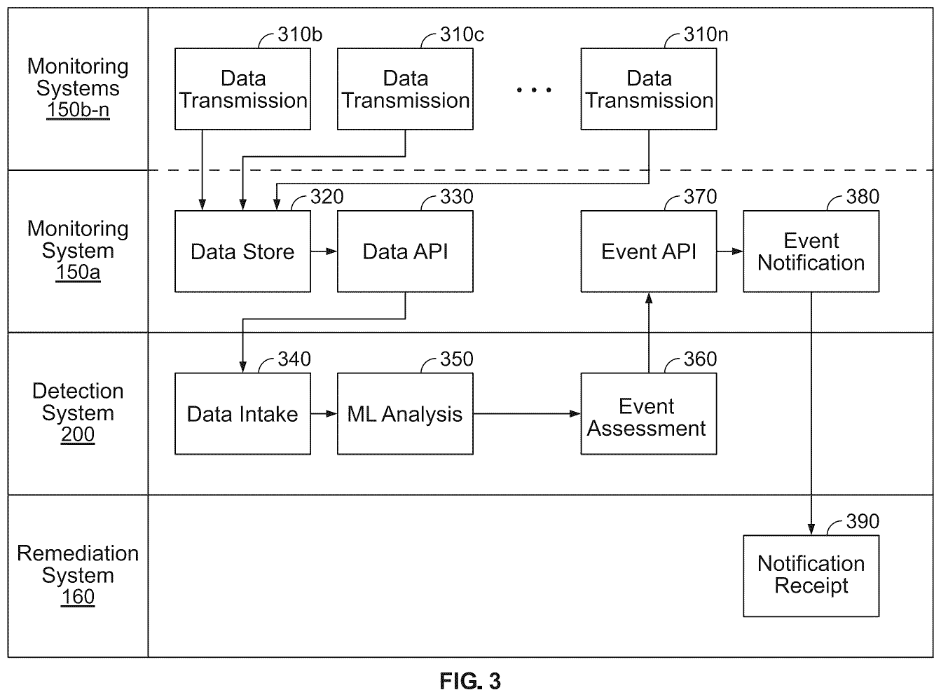

FIG. 3 depicts an example sequence of operation in which the detection system 200 detects and notifies of unperformed leasing event(s) for the property management system 100. In the illustrated example, the monitoring system 150a is an observability system (e.g, Datadog®) that collects data from other monitoring systems 150b-n.

Initially, the monitoring systems 150b-n collect raw source data that tracks the performance of monitored events. At blocks 310b-n, the monitoring systems 150b-n transmit the raw source data to the monitoring system 150a.

At block 320, the monitoring system aggregates and stores the raw source data collected from the other monitoring systems 150b-n. At block 330, the monitoring system 150a provides the raw source data to the detection system 200 via an application programming interface (API) for the raw source data.

At block 340, the detection system 200 stores the raw source data in the source database 230. The detection system 200 also reformats the raw source data into a format usable by the machine learning algorithm. Additionally, the detection system 200 provides configuration settings for the machine learning algorithm. At block 350, the detection system 200 enables machine learning analysis to be performed by providing the reformatted source data as inputs to the machine learning algorithm, such as a nonparametric regression model (e.g., an additive regression model), which generates confidence data indicative of how likely and/or frequently the automated event(s) are to have recently occurred. At block 360, the detection system 200 performs an event assessment using the confidence data and the to determine whether there were any recent unperformed event(s). In response to detecting an unperformed event, the detection system 200 generates an alert signal.

At block 370, the monitoring system 150a receives the alert signal generated by the detection system 200. At block 380, the monitoring system 150a generates transmits a corresponding alert notification via text message (e.g., a short messaging service (SMS) message), an email, an automated phone call, etc. At block 380, the remediation system 160 receives the alert notification.

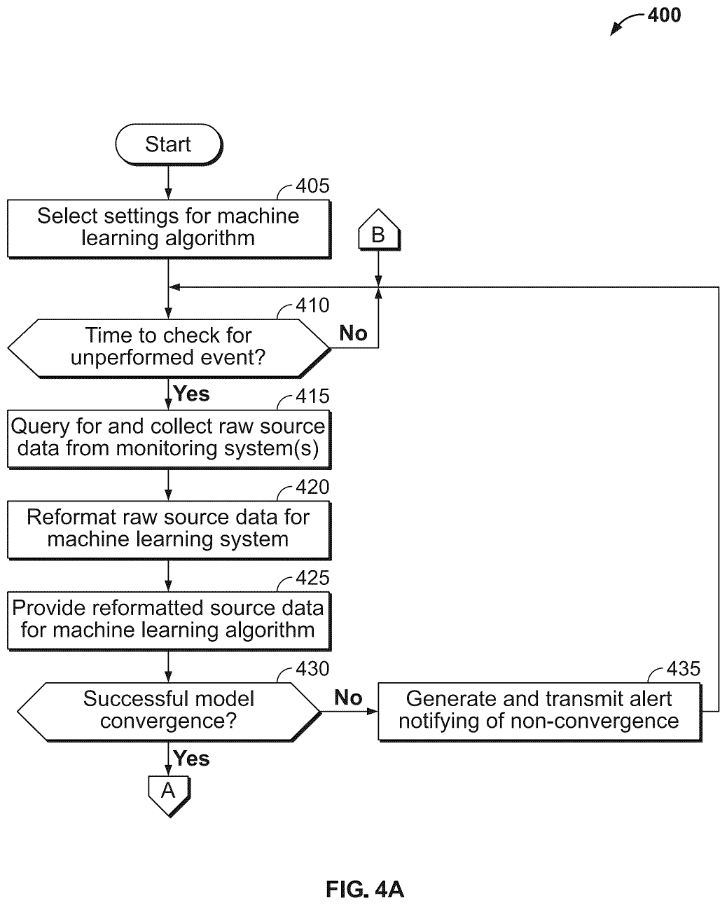

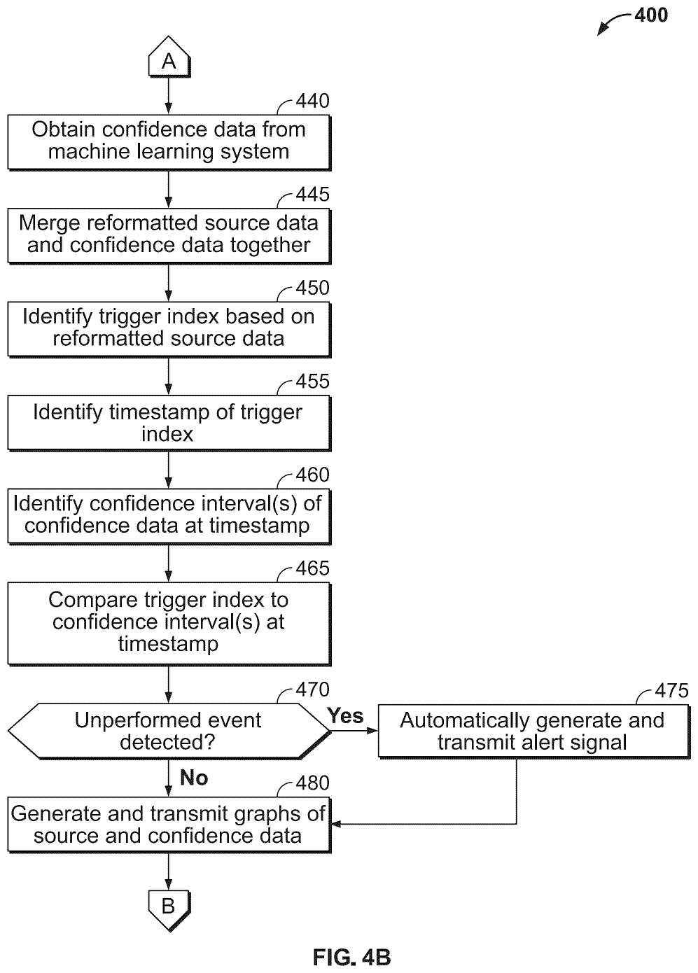

FIGS. 4A-4B depicts a flowchart of an example method 400 for the detection system 200 to detect and notify of unperformed event(s), such as unperformed leasing event(s) for the property management system 100. The flowchart of FIG. 4 is representative of machine readable instructions stored in memory (such as the memory 220 of FIG. 2) and include one or more programs, such as program(s) written in Python®, which, when executed by one or more processors (such as the processor(s) 210 of FIG. 2), cause the detection system 200 to detect and notify of unperformed event(s). While the example program is described with reference to the flowchart illustrated in FIG. 4, many other methods may alternatively be used. For example, the order of execution of the blocks may be rearranged, changed, eliminated, and/or combined to perform the method 400. Further, because the method 400 is disclosed in connection with the components of FIGS. 1-2, some functions of those components will not be described in detail below.

Initially, at block 405, the processor(s) 210 select settings for the ML system 170. Additionally, the processor(s) 210 are configured to store the configuration settings in the ML database 240.

The ML system 170 is configured to operate a machine learning algorithm, such as a nonparametric regression model. For example, the nonparametric regression model may be an additive regression model (e.g., Prophet of Meta®). Table 1 is provided below with an example list of configurations that may be set by the processor(s) 210 for an additive regression model, such as Prophet.

TABLE 1

| Configuration | |
|---|---|
| Name | Configuration Description |
| Metric Lookback | Number of days from which to start the dataset |
| Changepoint | List of dates at which to include potential |
| | changepoints |
| No. of Changepoints | Number of potential changepoints to include |
| Changepoint Range | Proportion of history in which trend changepoints |
| | will be estimated |
| Changepoint Prior | Modulation of flexibility of an automatic change- |
| Scale | point - larger values correspond with more change- |
| | points, small values correspond with fewer change- |
| | points |
| Interval Width | Width of the uncertainty intervals provided for the |
| | forecast |
| Holidays | Data frame specifying dates to be included as |
| | holidays |
| Holidays Mode | Either ‘additive’ (the default) or ‘multiplicative’ |
| Holidays Prior Scale | Modulation of strength of the holiday components |
| | model |
| Seasonality Mode | Either ‘additive’ (the default) or ‘multiplicative’ |
| Seasonality Prior | Modulation of strength of the holiday seasonality |
| Scale | model |
| Yearly Seasonality | Fit for yearly seasonality |
| Weekly Seasonality | Fit for weekly seasonality |
| Daily Seasonality | Fit for daily seasonality |
| Growth | Either ‘linear’, ‘logistic’ or ‘flat’ string to specify |
| | a linear, logistic or flat trend, respectively |
| Uncertainty Samples | Number of simulated draws used to estimate |
| | uncertainty intervals |
| MCMC Samples | Integer - If > 0, complete full Bayesian inference |
| | with the specified number of MCMC samples; if 0, |
| | complete MAP estimation |
| Stan Backend | String as defined in StanBackendEnum |
| Predict Periods | Number of time periods to forecast over |
| Predict Frequency | Time duration of each forecast prediction period |
| | window |

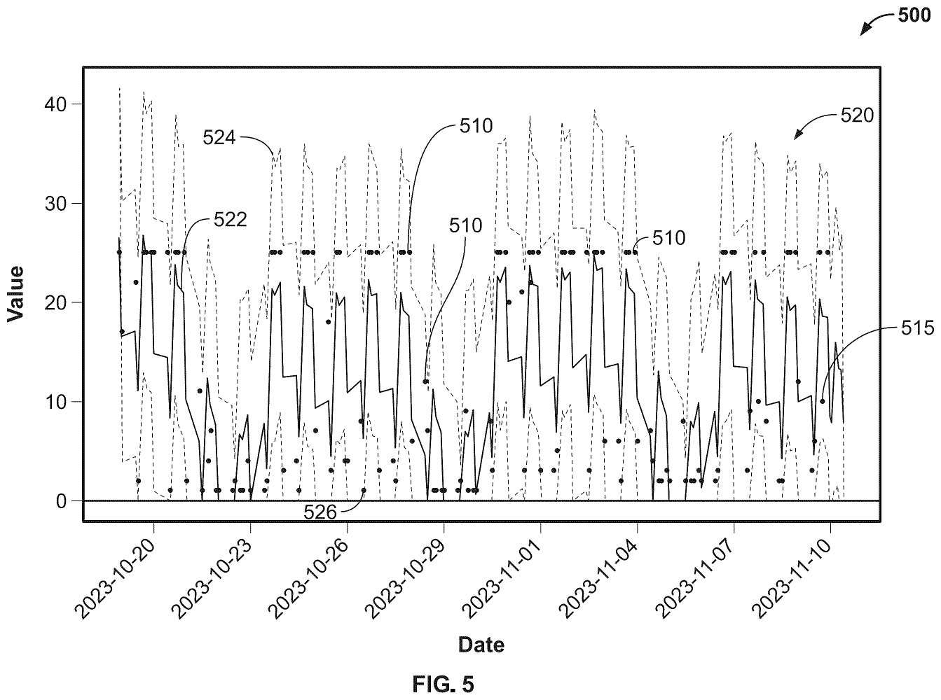

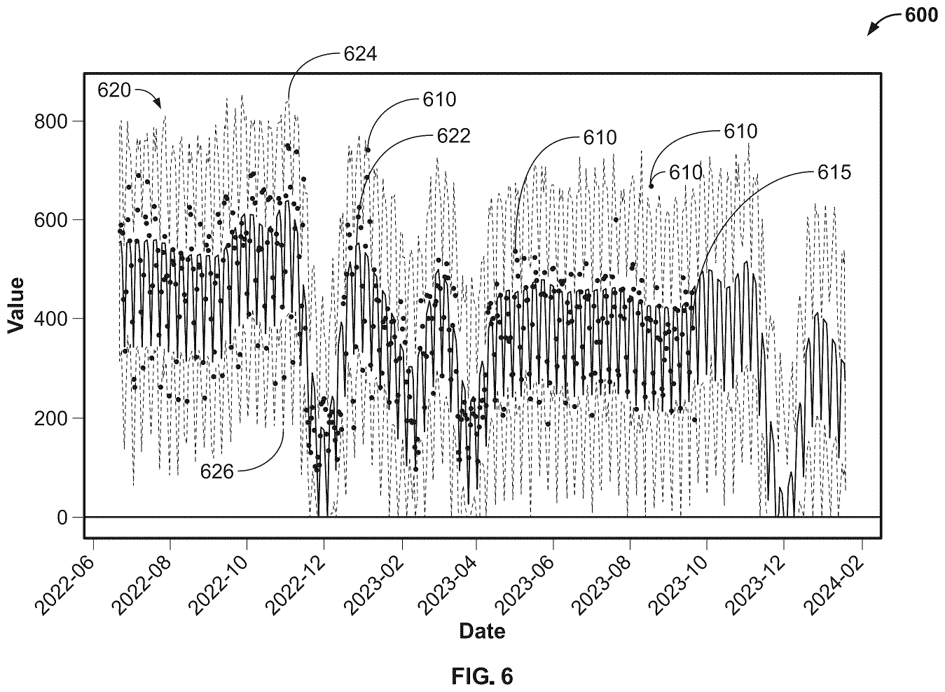

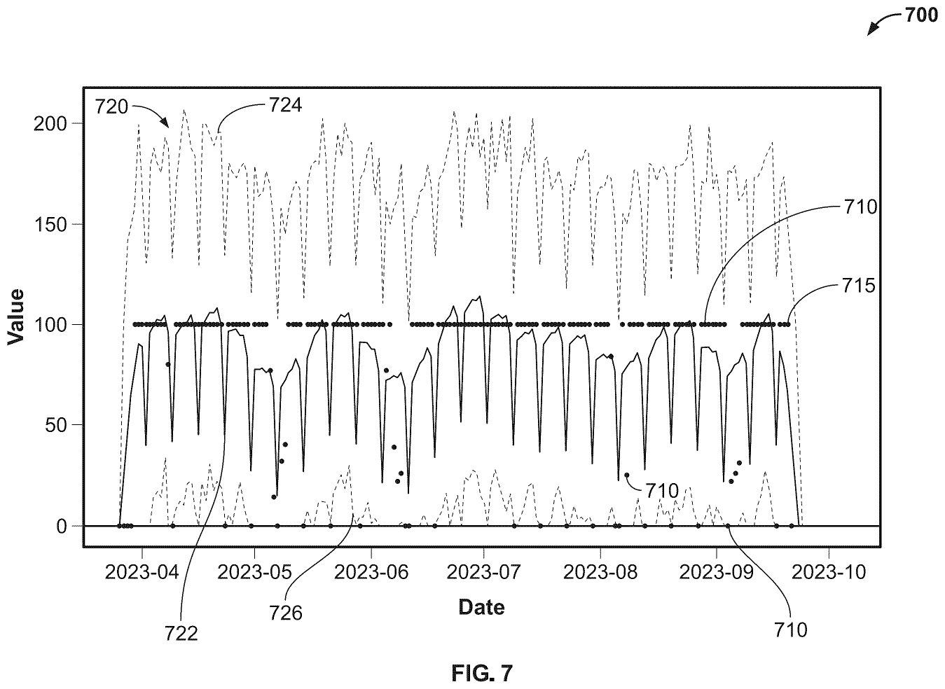

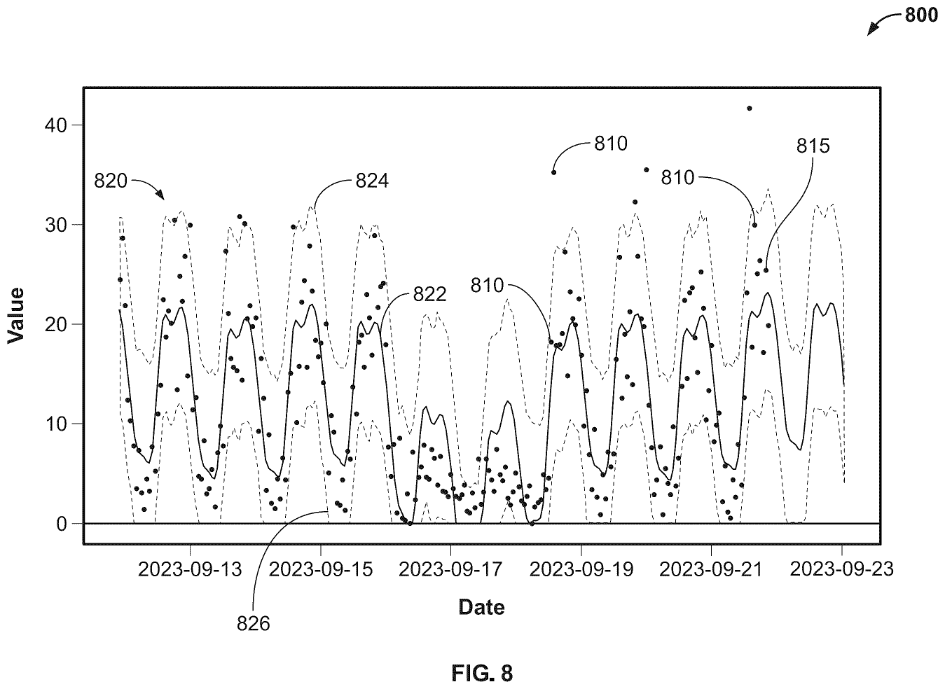

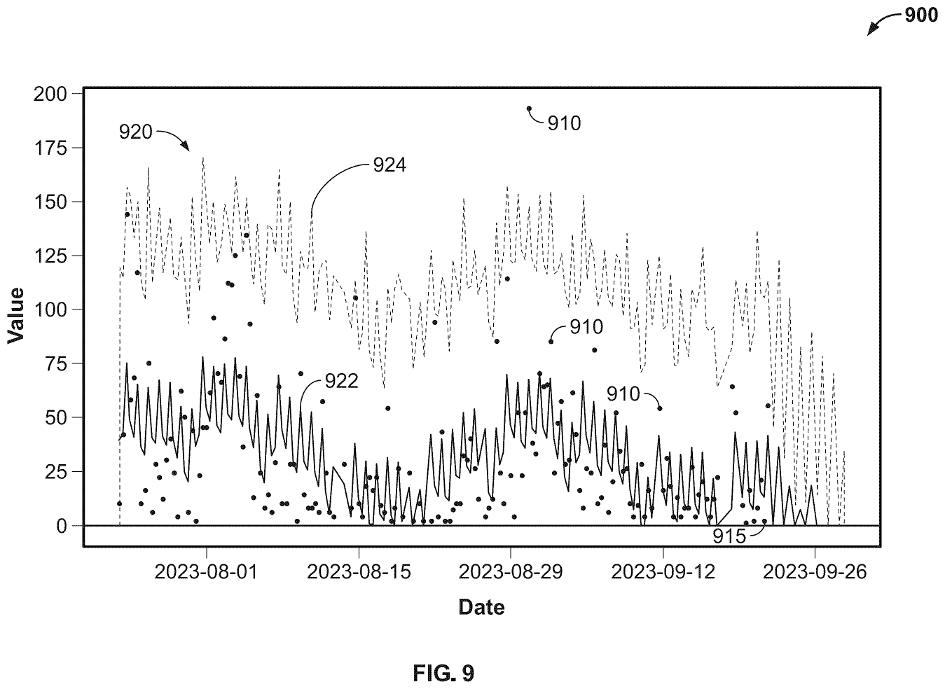

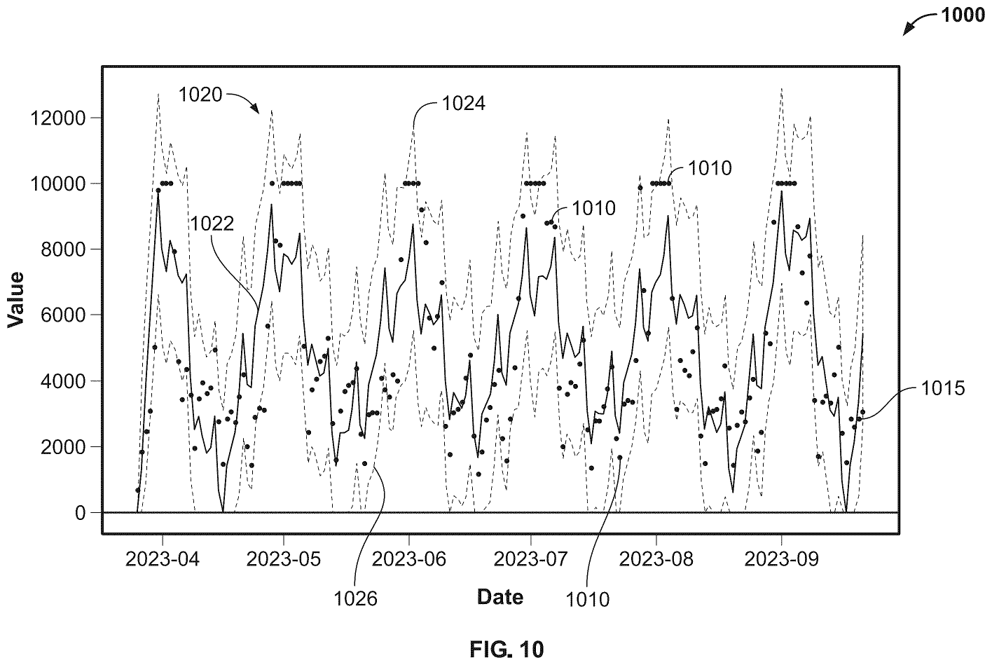

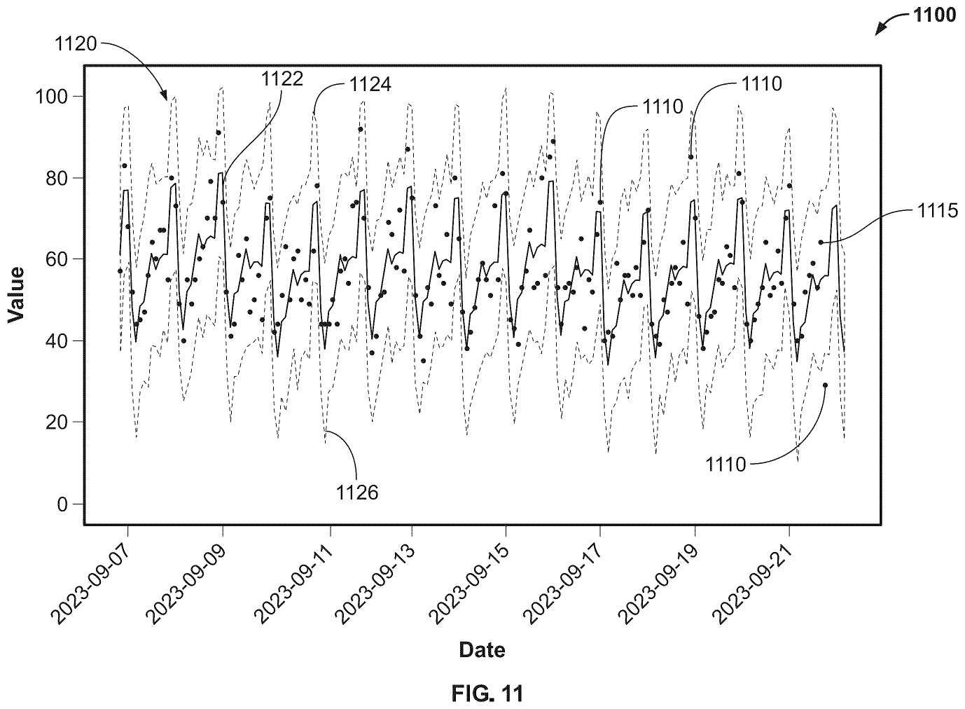

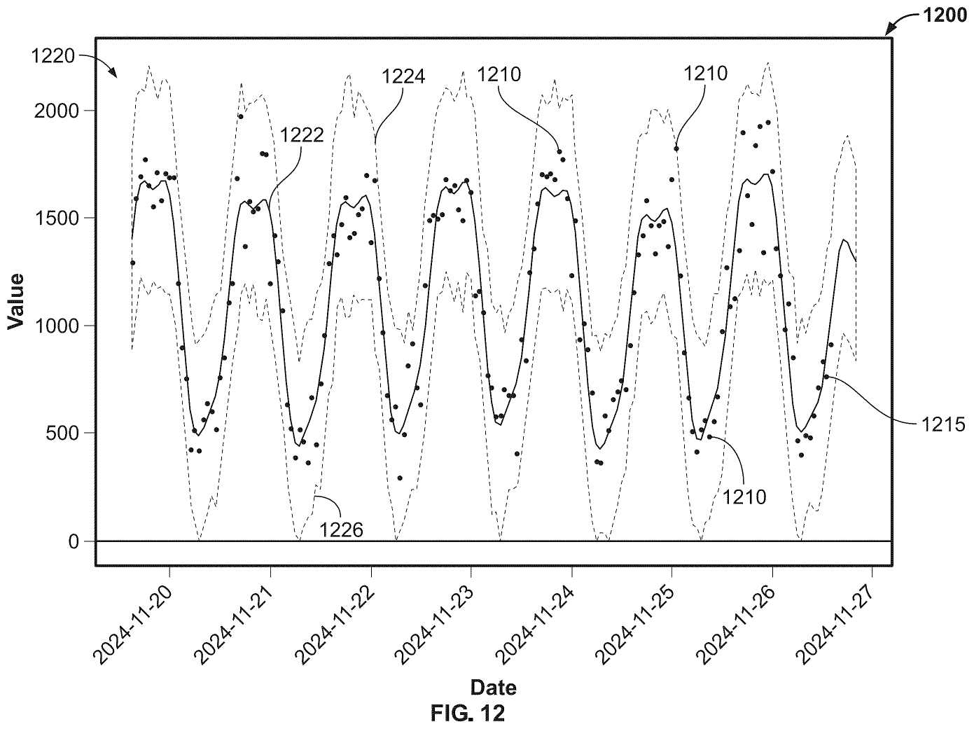

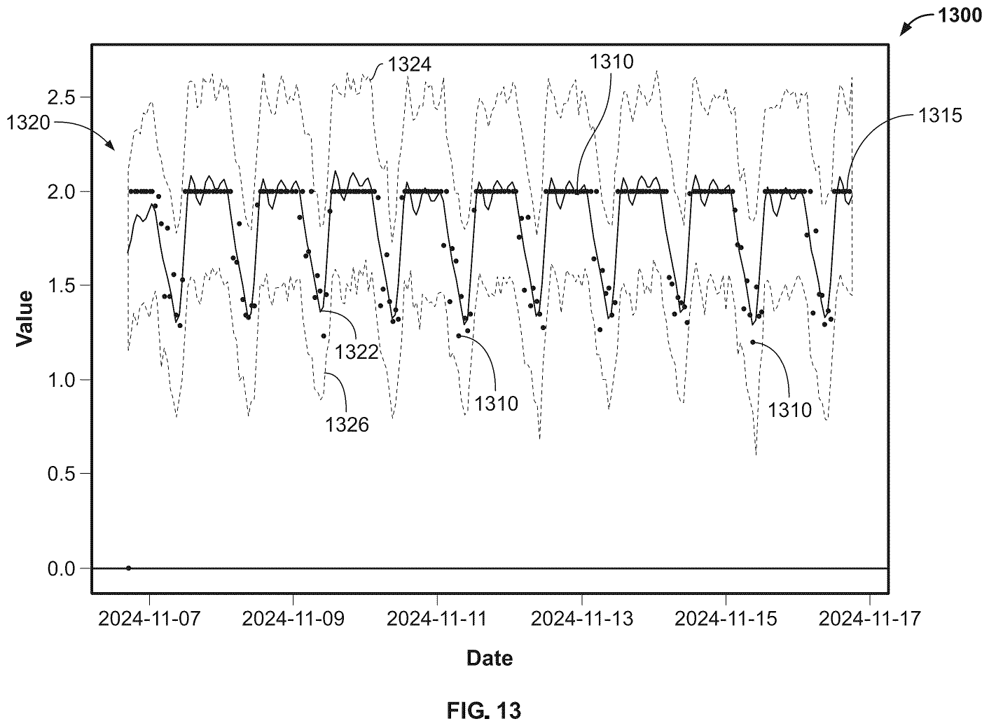

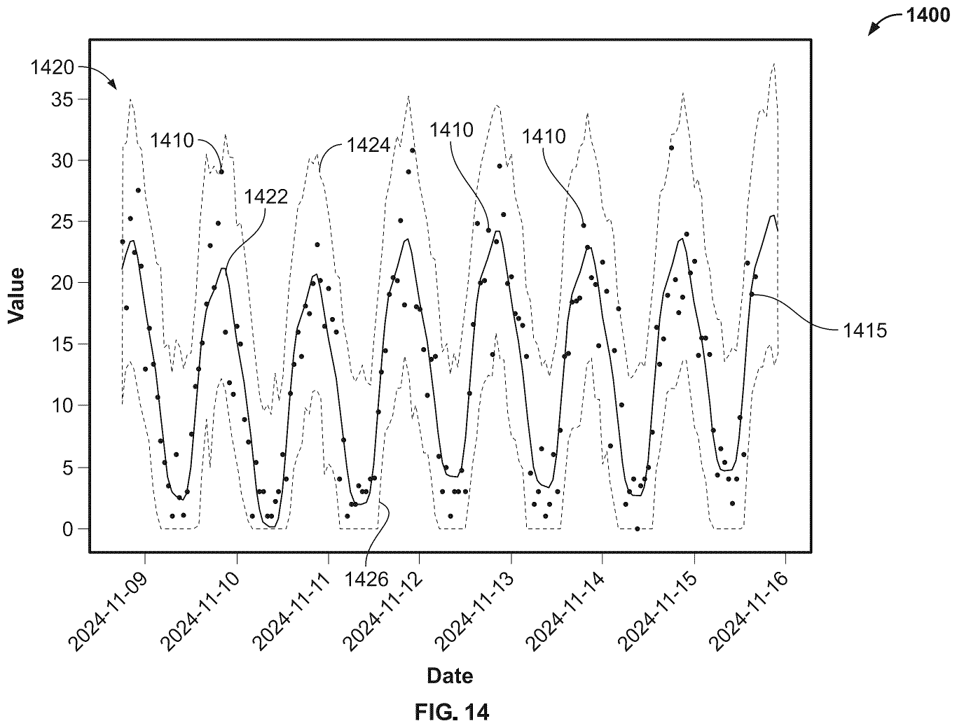

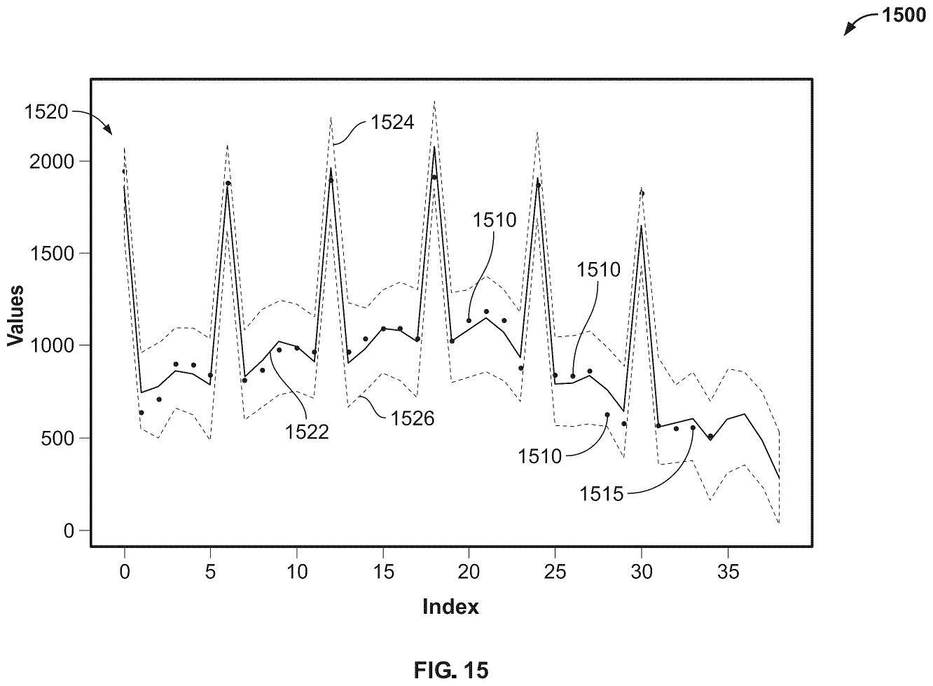

At block 410, the processor(s) 210 determine whether it is time to perform a check for unperformed event(s). Example unperformed leasing events include rent synchronizations (FIG. 5), lease submissions (FIG. 6), email transmissions for lease renewals (FIG. 7), file transfers (FIG. 8), error detection for lease payment processes (FIG. 9), financial payments (FIG. 10), tasks performed for a financial database system (FIG. 11), customer-requested app executions (FIG. 12), AI chatbot responses (FIG. 13), customer authentications (FIG. 14), multi-system processes (FIG. 15), etc. In some examples, the processor(s) 210 check for unperformed leasing event(s) at a predefined interval (e.g., once an hour, once a day, twice a day, once a week, etc.). For example, the predefined interval at which processor(s) 210 check for unperformed leasing event(s) is based on the “Predict Frequency” configuration set at block 405. Further, in some examples, the processor(s) 110 may check for unperformed leasing event(s) on demand and/or upon receiving a request.

In response to the processor(s) 210 determining that it is not time to check for unperformed leasing event(s), the method 400 remains at block 410. Otherwise, in response to the processor(s) 210 determining that it is time to check for unperformed leasing event(s), the method 400 proceeds to block 415 at which the processor(s) 210 query for and collect raw source data from the monitoring system(s) 150. Additionally, the processor(s) 210 store the raw source data in the source database 230.

The monitoring system(s) 150 include database(s) that store data associated with events being monitored for the property management system 100 (e.g., rent synchronizations, lease submissions, email transmissions for lease renewals, file transfers, payments for application payments, financial payments, task executions, customer-requested app executions, AI chatbot responses, customer authentications, multi-system processes, etc.). For example, each entry of the raw source data that is stored in such a database of a monitoring system 150 includes a numerical value for a metric being monitored and a corresponding timestamp. That is, the database of a monitoring system 150 includes a matrix of data with a plurality of entries organized in rows and a plurality of variables organized in columns. For example, one array (e.g., column) includes values for a metric being monitored (also referred to as a “y” value), and another array (e.g., column) includes corresponding timestamps (also referred to as “ds” values).

In some examples, the monitoring system(s) 150 from which the processor(s) 210 collect raw source data include an internal monitoring system (e.g., of the property management system 100), a financial monitoring system, and/or another third-party monitoring system (e.g., a software-as-a-service system such as Salesforce®). Additionally or alternatively, the monitoring system(s) 150 include an observability system (e.g, Datadog®) that aggregates and/or correlates raw data from other monitoring system(s) 150, such as internal monitoring system(s), financial monitoring system(s), and/or other third-party monitoring system(s).

At block 420, the processor(s) 210 reformat the raw source data collected from the monitoring system(s) 150 for the ML system 170. That is, the processor(s) 210 pre-process the raw source data to generate reformatted source data. Additionally, the processor(s) 210 store the reformatted source data in the source database 230.

The reformatted source data is in a usable format for the ML system 170 to enable the ML system 170 to feed the source data to the corresponding machine learning algorithm. For example, the raw source data collected from the monitoring system(s) 150 may initially be in a json format. The processor(s) 210 parse the raw source data to extract a pointlist portion that contains a full list of entries with monitored metric values and corresponding timestamps. The processor(s) 210 then convert the extracted pointlist to another data structure (Pandas DataFrame objects) that is compatible with the programming language in which the program(s) executed by the processor(s) 210 are written (e.g., Python®). Subsequently, the processor(s) 210 rename the monitored metric and timestamp columns to be in accordance with the naming convention of the machine learning algorithm (e.g., a nonparametric regression model such as an additive regression model) and reformat the timestamp values to be in a predefined datetime format (e.g., a DateTime format).

Turning to block 425, the processor(s) 210 provide the reformatted source data for the machine learning algorithm of the ML system 170. In some examples, the processor(s) 210 feed the reformatted source data as inputs to the machine learning algorithm of the ML system 170. In other examples, the processor(s) 210 provide the reformatted source data to the ML system 170, which then feeds the reformatted source data to the machine learning algorithm. That is, the ML system 170 and/or the processor(s) 210 of the property management system 100 run the machine learning algorithm.

The machine learning algorithm, such as a nonparametric regression model (e.g., an additive regression model), is run to generate output data based on the metric values and timestamps of the reformatted source data. Initially, the machine learning algorithm generates convergence data, which indicates whether model convergence was successful based on the selected configurations and the fed inputs. At block 430, the processor(s) 210 determine whether there was a successful model convergence based on the convergence data.

In response to the processor(s) 210 determining that there was not a successful model convergence, the method 400 proceeds to block 435 at which processor(s) 210 generate and transmit an alert notifying the remediation system 160 of the non-convergence of the machine learning algorithm. In some examples, the processor(s) 210 transmit the alert signal directly to the remediation system 160 in the form of a text message (e.g., a short messaging service (SMS) message), an email, an automated phone call, etc. In other examples, the alert signal transmitted by the processor(s) 210 is in the form of an application programming interface (API) event notification that is sent to a monitoring system 150, such as an observability system (e.g, Datadog®). The monitoring system 150 then sends an alert to the remediation system 160 via a text message (e.g., a short messaging service (SMS) message), an email, an automated phone call, etc.

Otherwise, in response to the processor(s) 210 determining that there was a successful model convergence, the method 400 proceeds to block 440 of FIG. 4B. At block 440, the processor(s) 210 obtain the confidence data as an output of the machine learning algorithm. For example, the confidence data is obtained in the form of a matrix with each row corresponding with a respective entry and each column corresponding with a respective value type. One column includes timestamps, another column includes mean values (also referred to as “y-hat” values) for the corresponding timestamps, another column includes lower confidence intervals (also referred to as “lower y-hat” values) for the corresponding timestamps, and/or another column includes upper confidence intervals (also referred to as “upper y-hat” values) for the corresponding timestamps. Each entry includes a corresponding value for each of the value types. Additionally, the processor(s) 210 store the confidence data in the ML database 240.

In some examples, the processor(s) processor(s) 210 apply a post-ML multiplier to the interval width to adjust the upper and/or lower confidence intervals of the confidence data. For example, the machine learning algorithm that generates the confidence data may limit the interval width configuration to be less than or equal to 1.0. Such an interval width value (i.e., less than or equal to 1.0) may result in falsely detected unperformed leasing events for instances in which the source data is particularly noisy. In such examples, the processor(s) 210 set the interval width value for the machine learning algorithm as 1.0 and subsequently select a post-ML multiplier (e.g., 1.05) that results in the targeted interval width value (e.g., 1.05). By increasing the interval width value with a post-ML multiplier, the processor(s) 210 are able to overcome the configuration limitations of the machine learning algorithm to eliminate and/or otherwise reduce a number of false positives for unperformed leasing events.

Turning to block 445, the processor(s) 210 merge the respective matrices of the reformatted source data and the confidence data together. For example, the processor(s) 210 merge the reformatted source data and the confidence data together by matching entries of the reformatted source with entries of the confidence data based on shared timestamps. Additionally, the processor(s) 210 store the merged data in the ML database 240. Further, in other examples, the reformatted source data and the confidence data remain unmerged from each other.

At block 450, the processor(s) 210 identify a trigger index that is to be used to detect a recent unperformed event. The trigger index corresponds with the value of the monitored metric for one of the entries of the source data. In some examples, to detect an unperformed event, the processor(s) 210 identify the most recent data entry with a complete set of data. The last data entry may reflect a partial data set if only a portion of a predefined period of time has been completed when the data was pulled. Hence, in such examples, the processor(s) 210 identify the value of the monitored metric of the second-most-recent data entry as the trigger index.

At block 455, the processor(s) 210 identify the timestamp that corresponds with the metric value selected as the trigger index. At block 460, the processor(s) 210 identify the upper confidence interval value, the lower confidence interval value, and/or the mean value that corresponds with the timestamp of the trigger index. At block 465, the processor(s) 210 compare the trigger index to the identified upper confidence interval value, lower confidence interval value, and/or mean value. For each timestamp, the corresponding mean value is indicative of the average expected value of the leasing event, the corresponding lower confidence interval value is indicative of a lower bound of the expected value of the leasing event, and the corresponding upper confidence interval value is indicative of an upper bound of the expected value.

At block 470, the processor(s) 210 determine whether unperformed event(s) have been detected based on the comparison between the trigger index and the confidence interval(s). In some examples, the processor(s) 210 detect an anomaly indicative of unperformed event(s) in response to determining that the trigger index is greater than the upper confidence interval value at the corresponding timestamp. In other examples, the processor(s) 210 detect an anomaly indicative of unperformed event(s) in response to determining that the trigger index is less than the lower confidence interval value at the corresponding timestamp. In other examples, the processor(s) 210 detect an anomaly indicative of unperformed event(s) in response to determining that the trigger index is greater than the upper confidence interval value at the corresponding timestamp or less than the lower confidence interval value at the corresponding timestamp. Further, in other examples, the processor(s) 210 detect an unperformed event based on a comparison between the trigger index and the mean value at the corresponding timestamp.

In response to the processor(s) 210 detecting unperformed event(s), the method 400 proceeds to block 475. Otherwise, in response to the processor(s) 210 not detecting unperformed event(s), the method 400 proceeds to block 480.

In other examples, instead of detecting the occurrence of unperformed event(s) based on a single trigger index, as executed by blocks 450, 455, 460, 465, 470, the processor(s) 210 detect unperformed event(s) upon determining that two or more consecutive reformatted source data fall outside of the corresponding confidence interval data. For example, for one or more entries of reformatted source data (e.g., each entry of reformatted source data), the processor(s) 210 (1) identify the timestamp of that entry and (2) identify the confidence interval(s) corresponding with that timestamp. In response to determining that a value of the monitored metric is outside of the confidence interval(s) for a data entry, the processor(s) 210 assign the corresponding metric value as a first trigger index. The processor(s) 210 then analyze the immediate preceding and/or subsequent data entry of the reformatted source data as a second trigger index to determine whether that data entry also falls outside of the corresponding confidence interval(s). The processor(s) 210 detect that unperformed event(s) have occurred in response to determining that two or more consecutive data entry are outside of the confidence interval(s).

Turning to block 475, the processor(s) 210 automatically generate and transmit an alert signal to notify the remediation system 160 of the unperformed event. In some examples, the processor(s) 210 transmit the alert signal directly to the remediation system 160 in the form of a text message (e.g., a short messaging service (SMS) message), an email, an automated phone call, etc. In other examples (e.g., as shown in FIG. 3), the alert signal transmitted by the processor(s) 210 is in the form of an application programming interface (API) event notification that is sent to a monitoring system 150, such as an observability system (e.g, Datadog®). The monitoring system 150 then sends an alert to the remediation system 160 via a text message (e.g., a short messaging service (SMS) message), an email, an automated phone call, etc. Upon receiving the alert, the remediation system 160 may then further investigate the issue to confirm the occurrence and/or identify the cause of unperformed event(s).

At block 480, the processor(s) 210 generate graph(s) depicting the comparison between the source data and the confidence data and/or the detection of any unperformed event(s). The processor(s) 210 may also store the generated graph(s) and/or underlying data in the assessment database 250.

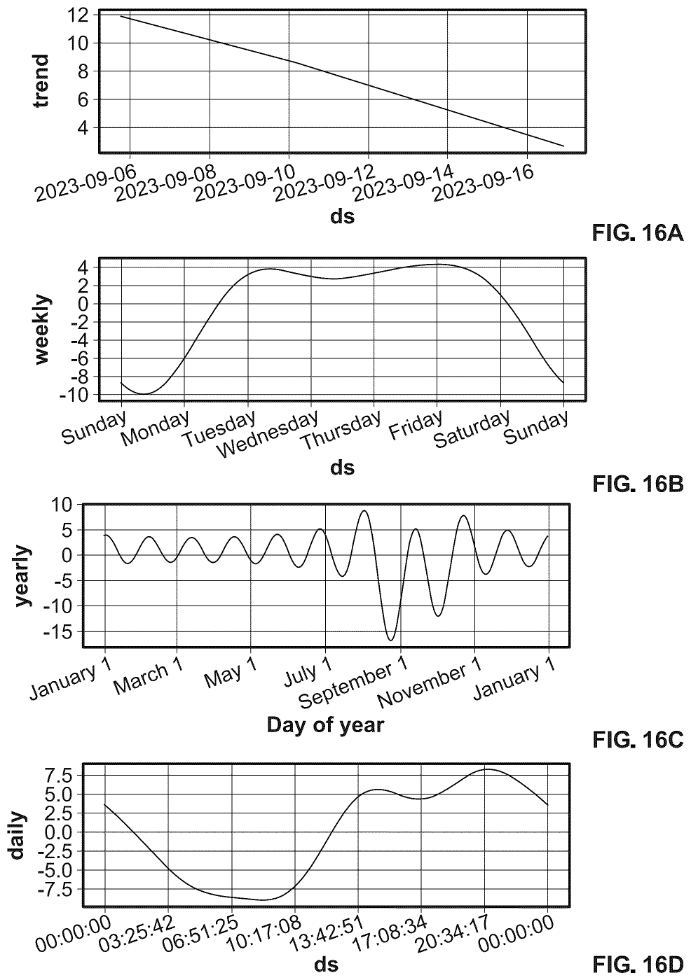

In some examples, the processor(s) 210 may overlay the entries of the source data on top of the confidence data to generate the graph(s). In some examples, such as those of FIGS. 5-11, the graph(s) generated by the processor(s) 210 depict source data and corresponding confidence data that are indicative of past events that have occurred to facilitate identification of recent unperformed events. Additionally or alternatively, the graph(s) generated by the processor(s) 210 include predictions of future data that is generated based on the data of past events to facilitate forecasts of future unperformed events. Further, in some examples, graph(s) generated by the processor(s) 210 are indicative of trends over predefined time periods. For example, FIG. 16A depicts a trendline over a 10-day window, FIG. 16B depicts a weekly trendline that is indicative of fluctuations in the frequency of a monitored metric throughout a calendar week, FIG. 16C depicts a yearly trendline that is indicative of fluctuations in the frequency of a monitored metric throughout a calendar year, and FIG. 16D depicts a daily trendline that is indicative of fluctuations in the frequency of a monitored metric throughout a day.

Turning to FIG. 5, an example graph 500 generated by the processor(s) 210 depicts source data that is overlaid on top of confidence data to facilitate monitoring of rent synchronizations performed by automated leasing systems.

The property management system 100 has automated system(s) in place to monitor when rent adjustments (e.g., increases) are reported to have occurred for rental properties. For example, the property management system 100 may use a plurality of the monitoring systems 150 to monitor for occurrences of rent adjustments in an automated manner. In such examples, two or more of the monitoring systems 150 are configured to record rent adjustments for rental properties. Such monitoring systems 150 may include a primary system (e.g., Yardi®), a financial system, a third-party system (e.g., Salesforce®), and/or an observability system (e.g, Datadog®). These rent adjustment recordings may be synchronized across the monitoring systems 150 over time. Sometimes an error may occur that prevents the rent adjustment synchronizations from temporarily occurring. Because the rent adjustment synchronizations occur irregularly throughout the day and/or week, it may be difficult for the monitoring system(s) 150 to identify when an error has occurred with the automated rent adjustment synchronization system.

The detection system 200 is configured to identify daily and/or weekly patterns among recent recordings of rent adjustment synchronizations to, in turn, detect when rent adjustment synchronization(s) have not been performed. The detection system 200 is configured to send a query to one of the monitoring system(s) 150 for source data (e.g., at block 415 of the method 400). For example, the queried source data may include data points, with each data point identifying a timestamp and a count of rent adjustment synchronizations that occurred at the corresponding timestamp. That is, the monitored metric is rent adjustment synchronizations, and the metric value is the quantity of rent adjustment synchronizations associated with a corresponding timestamp. The query may also cap the maximum value of rent adjustment synchronizations for each data point to a predefined number (e.g., 25) to avoid outlier data from distorting the daily and/or weekly patterns of the rent adjustment synchronizations. An example query request to the monitoring system(s) 150 for the source data of rent adjustment synchronizations is as follows: “clamp_max ((avg: market_rent_sync.residence_pulled_from_salesforce{*}),25)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with rent adjustment synchronization occurrences is provided below in Table 2:

TABLE 2

| Configuration | Configuration Setting |
|---|---|
| Metric Lookback | 22 |
| Changepoint Prior Scale | 0.4 |
| Seasonality Prior Scale | 2− |
| Yearly Seasonality | False |
| Weekly Seasonality | True |
| Daily Seasonality | True |
| Interval Width | 0.98 |
| Predict Periods | 12 |
| Predict Frequency | 1 hour (“1 H”) |

The source data is then fed to the machine learning algorithm, such as a nonparametric regression model (e.g., an additive regression model), which then generates confidence data associated with rent adjustment synchronization occurrences as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring for recent unperformed rent adjustment synchronizations, the detection system 200 identifies the quantity of rent adjustment synchronizations of the second-most-recent data entry as the trigger index. The detection system 200 also is configured identify the timestamp that corresponds with the selected trigger index (e.g., at block 455 of the method 400). To identify unperformed rent adjustment synchronization(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of unperformed rent adjustment synchronization(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent unperformed rent adjustment synchronization(s) at a predefined interval (e.g., once every 15 minutes) throughout the day to enable the detection system 200 to detect unperformed rent adjustment synchronization(s) at any time throughout the day.

Upon detecting unperformed rent adjustment synchronization(s), the detection system 200 is configured to generate and transmit an alert signal to notify the remediation system 160 of the unperformed rent adjustment synchronization(s) (e.g., at block 475 of the method 400). The remediation system 160 then is to further investigate the issue to confirm the occurrence and/or identify the cause of the automated system not performing the rent adjustment synchronization(s).

Additionally, the detection system 200 is configured to generate the graph 500 that depicts the comparison between the source data and the comparison data (e.g., at block 480 of the method 400). In the illustrated example, the graph 500 depicts a plurality of data points 510 of the source data, including a trigger index 515. The graph 500 also depicts comparison data 520. In particular, the graph 500 depicts a line 522 (also referred to as a “mean line”) indicative of the mean values across the depicted period of time. The graph 500 depicts a line 524 (also referred to as an “upper confidence interval line” and an “upper confidence line”) indicative of the upper confidence interval values across the depicted period of time. The graph 500 also depicts a line 526 (also referred to as a “lower confidence interval line” and a “lower confidence line”) indicative of the lower confidence interval values across the depicted period of time.

Turning to FIG. 6, an example graph 600 generated by the processor(s) 210 depicts source data that is overlaid on top of confidence data to facilitate monitoring of lease submissions performed by automated leasing systems.

The property management system 100 has automated system(s) in place to monitor when leases have been submitted to the property management system 100 for rental properties. For example, the property management system 100 may use one or more of the monitoring system(s) 150 to track lease submissions in an automated manner. Sometimes an error may occur that temporarily prevents one or more leases from being submitted to the property management system 100. Because lease submissions may occur irregularly throughout the day and/or week, it may be difficult for the monitoring system(s) 150 to identify when an error has occurred with the automated lease submission system.

The detection system 200 is configured to identify daily and/or weekly patterns among recent recordings of lease submissions to, in turn, detect when lease submissions have not been performed. The detection system 200 is configured to send a query to one of the monitoring system(s) 150 for source data (e.g., at block 415 of the method 400). For example, the queried source data may include data points, with each data point identifying a timestamp and a count of lease submissions that occurred at the corresponding timestamp. That is, the monitored metric is lease submissions, and the metric value is the quantity of lease submissions associated with a corresponding timestamp. The query may also cap the maximum value of lease submissions for each data point to a predefined number (e.g., 1,000) to avoid outlier data from distorting the daily and/or weekly patterns of the lease submissions. An example query request to the monitoring system(s) 150 for the source data of lease submissions is as follows: “clamp_max (sum:sqlserver.voyager.submit_application{*}.as_count( ).rollup (sum,36 00),1000)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with lease submissions is provided below in Table 3:

TABLE 3

| Configuration | Configuration Setting |
|---|---|
| Metric Lookback | 700 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 1.0 |
| Predict Periods | 120 |
| Predict Frequency | 1 day (“1 D”) |

The source data is then fed to the machine learning algorithm, such as a nonparametric regression model (e.g., an additive regression model), which then generates confidence data associated with lease submissions as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring for lease submissions, the detection system 200 identifies the quantity of lease submissions of the second-most-recent data entry as the trigger index. The detection system 200 also is configured identify the timestamp that corresponds with the selected trigger index (e.g., at block 455 of the method 400). To identify unperformed lease submission(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of recent unperformed lease submission(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent unperformed lease submission(s) at a predefined interval throughout the day and/or week to facilitate detection of unperformed lease submission(s).

Upon detecting unperformed lease submission(s), the detection system 200 is configured to generate and transmit an alert signal to notify the remediation system 160 of the unperformed lease submission(s) (e.g., at block 475 of the method 400). The remediation system 160 then is to further investigate the issue to confirm the occurrence and/or identify the cause of the automated system not performing the lease submission(s).

Additionally, the detection system 200 is configured to generate the graph 600 that depicts the comparison between the source data and the comparison data (e.g., at block 480 of the method 400). In the illustrated example, the graph 600 depicts a plurality of data points 610 of the source data, including a trigger index 615. The graph 600 also depicts comparison data 620. In particular, the graph 600 depicts a line 622 indicative of the mean values across the depicted period of time. The graph 600 depicts a line 624 indicative of the upper confidence interval values and another line 626 indicative of the lower confidence interval values.

Turning to FIG. 7, an example graph 700 generated by the processor(s) 210 depicts source data that is overlaid on top of confidence data to facilitate monitoring of emails for lease renewals sent by automated leasing systems.

The property management system 100 has automated system(s) in place to monitor when the property management system 100 has sent emails for lease renewals of rental properties. For example, the property management system 100 may use one or more of the monitoring system(s) 150 to track lease renewal emails in an automated manner. Sometimes an error may occur that temporarily prevents one or more lease renewal emails from being sent by the property management system 100. Because such emails may be sent at irregular intervals throughout the day and/or week, it may be difficult for the monitoring system(s) 150 to identify when error(s) have occurred with the automated lease renewal email system.

The detection system 200 is configured to identify daily and/or weekly patterns among recent recordings of email transmissions for lease renewals to, in turn, detect when lease renewal have not been sent. The detection system 200 is configured to send a query to one of the monitoring system(s) 150 for source data (e.g., at block 415 of the method 400). For example, the queried source data may include data points, with each data point identifying a timestamp and a quantity of lease renewal emails that were sent at the corresponding timestamp. That is, the monitored metric is lease renewal email transmissions, and the metric value is the quantity of lease renewal emails associated with a corresponding timestamp. The query may also cap the maximum value of email transmissions for each data point to predefined number (e.g., 100) to avoid outlier data from distorting the daily and/or weekly patterns of the lease renewal emails. An example query request to the monitoring system(s) 150 for the source data of email transmissions for lease renewals is as follows: “clamp_max(monotonic_diff(max:sfmc.email_journey.send.count{journey:general_renewal} by {journey}.as_count( )),100)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with email transmissions for lease renewals is provided below in Table 4:

TABLE 4

| Configuration | Configuration Setting |
|---|---|
| Metric Lookback | 180 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 1.0 |
| Predict Periods | 14 |
| Predict Frequency | 1 day (“1 D”) |

The source data is then fed to the machine learning algorithm, such as a nonparametric regression model (e.g., an additive regression model), which then generates confidence data associated with email transmissions for lease renewals as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring for the quantity of lease renewals, the detection system 200 identifies the quantity of lease renewal emails of the second-most-recent data entry as the trigger index. The detection system 200 also is configured identify the timestamp that corresponds with the selected trigger index (e.g., at block 455 of the method 400). To identify unsent lease renewal emails, the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of lease renewal email(s) having not been sent recently in response to determining that the trigger index is below the identified lower confidence interval value (e.g., at block 470 of the method 400). That is, the alert mode is a “below confidence interval (BCI)” type. In some examples, the detection system 200 is configured to monitor for recent unsent lease renewal email(s) at a predefined interval throughout the day and/or week to facilitate detection of unsent lease renewal email(s).

Upon detecting unsent lease renewal email(s), the detection system 200 is configured to generate and transmit an alert signal to notify the remediation system 160 of the unsent lease renewal email(s) (e.g., at block 475 of the method 400). The remediation system 160 then is to further investigate the issue to confirm the occurrence and/or identify the cause of the automated system not sending the lease renewal email(s).

Additionally, the detection system 200 is configured to generate the graph 700 that depicts the comparison between the source data and the comparison data (e.g., at block 480 of the method 400). In the illustrated example, the graph 700 depicts a plurality of data points 710 of the source data, including a trigger index 715. The graph 700 also depicts comparison data 720. In particular, the graph 700 depicts a line 722 indicative of the mean values across the depicted period of time. The graph 700 also depicts a line 724 indicative of the upper confidence interval values and another line 726 indicative of the lower confidence interval values.

Turning to FIG. 8, an example graph 800 generated by the processor(s) 210 depicts source data that is overlaid on top of confidence data to facilitate monitoring of file transfer transactions between the property management system 100 and external systems that are performed by automated leasing systems.

The property management system 100 has automated system(s) in place to monitor file transfer transactions of the property management system 100. For example, the property management system 100 may use one or more of the monitoring system(s) 150 to track file transfers in an automated manner. Sometimes an error may occur that temporarily prevents one or more file transfers from being performed with the property management system 100. Because such file transfers may occur at irregular intervals throughout the day and/or week, it may be difficult for the monitoring system(s) 150 to identify when error(s) have occurred with the automated file transfer system.

The detection system 200 is configured to identify daily and/or weekly patterns among recent recordings of file transfers to, in turn, detect when file transfers have not been performed. The detection system 200 is configured to send a query to one of the monitoring system(s) 150 for source data (e.g., at block 415 of the method 400). For example, the queried source data may include data points, with each data point identifying a timestamp and a quantity of file transfers that occurred at the corresponding timestamp. That is, the monitored metric is file transfers and the metric value is the quantity of file transfers associated with a corresponding timestamp. An example query request to the monitoring system(s) 150 for the source data of file transfers is as follows: “sum:aws.transfer.files_in{*}.rollup(sum,3600)+sum:aws.tranfer.files_out{*}.rollup (sum,3600)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with file transfers is provided below in Table 5:

TABLE 5

| Configuration | Configuration Setting |
|---|---|
| Metric Lookback | 10 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 0.95 |
| Predict Periods | 28 |
| Predict Frequency | 1 hour (“1 H”) |

The source data is then fed to the machine learning algorithm, such as a nonparametric regression model (e.g., an additive regression model), which then generates confidence data associated with file transfers as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring for unperformed file transfer(s), the detection system 200 identifies the quantity of file transfers of the second-most-recent data entry as the trigger index. The detection system 200 also is configured identify the timestamp that corresponds with the selected trigger index (e.g., at block 455 of the method 400). To identify unperformed file transfer(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of recent unperformed file transfer(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent unperformed file transfer(s) at a predefined interval throughout the day and/or week to facilitate detection of file transfer(s) that have not been performed by the property management system 100.

Upon detecting unperformed file transfer(s), the detection system 200 is configured to generate and transmit an alert signal to notify the remediation system 160 of the unperformed file transfer(s) (e.g., at block 475 of the method 400). The remediation system 160 then is to further investigate the issue to confirm the occurrence and/or identify the cause of the automated system not performing the file transfer(s).

Additionally, the detection system 200 is configured to generate the graph 800 that depicts the comparison between the source data and the comparison data (e.g., at block 480 of the method 400). In the illustrated example, the graph 800 depicts a plurality of data points 810 of the source data, including a trigger index 815. The graph 800 also depicts comparison data 820. In particular, the graph 800 depicts a line 822 indicative of the mean values across the depicted period of time. The graph 800 also depicts a line 824 indicative of the upper confidence interval values and another line 826 indicative of the lower confidence interval values.

Turning to FIG. 9, an example graph 900 generated by the processor(s) 210 depicts source data that is overlaid on top of confidence data to facilitate monitoring the quantity of errors detected during lease payment processes that are performed by automated leasing systems.

The property management system 100 has automated system(s) in place to monitor error rates of lease payments to the property management system 100 for rental properties. For example, the property management system 100 may use one or more of the monitoring system(s) 150 to track when lease payments have been made and how frequently errors have occurred with those payments. Sometimes an error may occur with the monitoring system(s) 150 and/or the property management system 100 that temporarily and causes errors with lease payments to improperly occur. Because lease payments may occur irregularly throughout the day and/or week, it may be difficult for the monitoring system(s) 150 to identify when an error has occurred with the automated lease payment system.

The detection system 200 is configured to identify daily and/or weekly patterns among recent recordings of error rates of lease payments to, in turn, detect when lease payment(s) have not been performed. The detection system 200 is configured to send a query to one of the monitoring system(s) 150 for source data (e.g., at block 415 of the method 400). For example, the queried source data may include data points, with each data point identifying a timestamp and an error rate count of lease payments that occurred at the corresponding timestamp. That is, the monitored metric is error rates of lease payments, and the metric value is the error rate associated with a corresponding timestamp. An example query request to the monitoring system(s) 150 for the source data of a count of errors for lease payments in a time range is as follows: “moving_rollup(sum:sqlserver.voyager.payment_status{payment_status:error}.as_count( ), 5400,\” sum\ “)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with error rates of lease payments is provided below in Table 6:

TABLE 6

| Configuration | Configuration Setting |
|---|---|
| Metric Lookback | 60 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 1.0 |
| Predict Periods | 14 |
| Predict Frequency | 12 hours (“12 H”) |

The source data is then fed to the machine learning algorithm, such as a nonparametric regression model (e.g., an additive regression model), which then generates confidence data associated with error rates of lease payments as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring error rates of lease payments, the detection system 200 identifies the error rates of the second-most-recent data entry as the trigger index. The detection system 200 also is configured identify the timestamp that corresponds with the selected trigger index (e.g., at block 455 of the method 400). To identify unperformed lease payment(s), the detection system 200 is configured to identify the upper confidence interval value that corresponds with the timestamp of the trigger index (e.g., at block 460 of the method 400). The detection system 200 is then configured to compare the trigger index to the identified upper confidence interval value (e.g., at block 465 of the method 400). The detection system 200 is configured to detect an anomaly indicative of recent unperformed lease payment(s) in response to determining that the trigger index is above the identified upper confidence interval value (e.g., at block 470 of the method 400). That is, the alert mode is a “above confidence interval (ACI)” type. In some examples, the detection system 200 is configured to monitor for recent lease payment error(s) at a predefined interval (e.g., 1.5 hours) throughout the day and/or week to facilitate detection of unperformed lease payment(s).

Upon detecting lease payment error(s), the detection system 200 is configured to generate and transmit an alert signal to notify the remediation system 160 of the unperformed lease payment(s) (e.g., at block 475 of the method 400). The remediation system 160 then is to further investigate the issue to confirm the occurrence and/or identify the cause of the automated system not performing lease payment(s).

Additionally, the detection system 200 is configured to generate the graph 900 that depicts the comparison between the source data and the comparison data (e.g., at block 480 of the method 400). In the illustrated example, the graph 900 depicts a plurality of data points 910 of the source data, including a trigger index 915. The graph 900 also depicts comparison data 920. In particular, the graph 900 depicts a line 922 indicative of the mean values across the depicted period of time. The graph 900 also depicts a line 924 indicative of the upper confidence interval values.

Turning to FIG. 10, an example graph 1000 generated by the processor(s) 210 depicts source data that is overlaid on top of confidence data to facilitate monitoring of financial payments performed by automated leasing systems.

The property management system 100 has automated system(s) in place to monitor financial payments for the property management system 100. For example, the property management system 100 may use one or more of the monitoring system(s) 150 to track financial payments in an automated manner. Sometimes an error may occur that temporarily prevents one or more financial payments from being performed for the property management system 100. Because such payments may be sent at irregular intervals throughout the day and/or week, it may be difficult for the monitoring system(s) 150 to identify when an error has occurred with the automated financial payment system.

The detection system 200 is configured to identify daily and/or weekly patterns among recent recordings of financial payments to, in turn, detect when financial payment(s) have not been performed. The detection system 200 is configured to send a query to one of the monitoring system(s) 150 for source data (e.g., at block 415 of the method 400). For example, the queried source data may include data points, with each data point identifying a timestamp and a quantity of financial payments that occurred at the corresponding timestamp. That is, the monitored metric is financial payments, and the metric value is the quantity of financial payments associated with a corresponding timestamp. The query may also cap the maximum value of financial payments for each data point to predefined number (e.g., 10,000) to avoid outlier data from distorting the daily and/or weekly patterns of the financial payments. An example query request to the monitoring system(s) 150 for the source data of financial payments is as follows: “clamp_max(sum:sqlserver.voyager.payment_status{*}.as.count( ).rollup(max,3600), 10000)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with financial payments is provided below in Table 7:

TABLE 7

| Configuration | Configuration Setting |
|---|---|
| Metric Lookback | 180 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 0.93 |
| Predict Periods | 0 |
| Predict Frequency | 1 day (“1 D”) |

The source data is then fed to the machine learning algorithm, such as a nonparametric regression model (e.g., an additive regression model), which then generates confidence data associated with financial payments as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring the quantity of financial payments, the detection system 200 identifies the number of financial payments of the second-most-recent data entry as the trigger index. The detection system 200 also is configured identify the timestamp that corresponds with the selected trigger index (e.g., at block 455 of the method 400). To identify unperformed financial payment(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of recent unperformed financial payment(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent unperformed financial payment(s) at a predefined interval (e.g., 1 hour) throughout the day and/or week to facilitate detection of unperformed financial payment(s).

Upon detecting unperformed financial payment(s), the detection system 200 is configured to generate and transmit an alert signal to notify the remediation system 160 of the unperformed financial payment(s) (e.g., at block 475 of the method 400). The remediation system 160 then is to further investigate the issue to confirm the occurrence and/or identify the cause of the automated system not performing financial payment(s).

Additionally, the detection system 200 is configured to generate the graph 1000 that depicts the comparison between the source data and the comparison data (e.g., at block 480 of the method 400). In the illustrated example, the graph 1000 depicts a plurality of data points 1010 of the source data, including a trigger index 1015. The graph 1000 also depicts comparison data 1020. In particular, the graph 1000 depicts a line 1022 indicative of the mean values across the depicted period of time. The graph 1000 also depicts a line 1024 indicative of the upper confidence interval values and another line 1026 indicative of the lower confidence interval values.

Turning to FIG. 11, an example graph 1100 generated by the processor(s) 210 depicts source data that is overlaid on top of confidence data to facilitate monitoring of task executions of financial database system(s) performed by automated leasing systems.

The property management system 100 has automated system(s) in place to monitor when financial database tasks have been executed for the property management system 100. For example, the property management system 100 may use one or more of the monitoring system(s) 150 to track task executions of financial database system(s) in an automated manner. Sometimes an error may occur that temporarily prevents one or more database tasks from being executed. Because leases may be submitted at irregular intervals throughout the day and/or week, it may be difficult for the monitoring system(s) 150 to identify when an error has occurred with the automated financial database system(s) tracking system.

The detection system 200 is configured to identify daily and/or weekly patterns among recent recordings of financial database task executions to, in turn, detect when financial database task executions have not been performed. The detection system 200 is configured to send a query to one of the monitoring system(s) 150 for source data (e.g., at block 415 of the method 400). For example, the queried source data may include data points, with each data point identifying a timestamp and a count of task executions that occurred at the corresponding timestamp. That is, the monitored metric is financial database task executions, and the metric value is the quantity of financial database task executions associated with a corresponding timestamp. An example query request to the monitoring system(s) 150 for the source data of financial database task executions is as follows: “sum:sqlserver.voyager.task_weight{*}.as_count( ).rollup(max,3600)”. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with financial database task executions is provided below in Table 8:

TABLE 8

| Configuration | Configuration Setting |
|---|---|
| Metric Lookback | 15 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 1.0 |
| Predict Periods | 5 |
| Predict Frequency | 2 hours (“2 H”) |

The source data is then fed to the machine learning algorithm, such as a nonparametric regression model (e.g., an additive regression model), which then generates confidence data associated with financial database task executions as an output. The confidence data outputted by the machine learning algorithm includes timestamps and corresponding mean values, lower confidence intervals, and upper confidence intervals.

The detection system 200 is configured to configured to identify a trigger index (e.g., at block 450 of the method 400). When monitoring for financial database task executions, the detection system 200 identifies the quantity of task executions of the second-most-recent data entry as the trigger index. The detection system 200 also is configured identify the timestamp that corresponds with the selected trigger index (e.g., at block 455 of the method 400). To identify unperformed financial database task execution(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of recent unperformed task execution(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent unperformed task execution(s) at a predefined interval throughout the day and/or week to facilitate detection of unperformed financial database task execution(s).

Upon detecting an unperformed financial database task execution, the detection system 200 is configured to generate and transmit an alert signal to notify the remediation system 160 of the unperformed financial database task execution(s) (e.g., at block 475 of the method 400). The remediation system 160 then is to further investigate the issue to confirm the occurrence and/or identify the cause of the automated system not performing financial database task execution(s).

Additionally, the detection system 200 is configured to generate the graph 1100 that depicts the comparison between the source data and the comparison data (e.g., at block 480 of the method 400). In the illustrated example, the graph 1100 depicts a plurality of data points 1110 of the source data, including a trigger index 1115. The graph 1100 also depicts comparison data 1120. In particular, the graph 1100 depicts a line 1122 indicative of the mean values across the depicted period of time. The graph 1100 also depicts a line 1124 indicative of the upper confidence interval values and another line 1126 indicative of the lower confidence interval values.

Turning to FIG. 12, an example graph 1200 generated by the processor(s) 210 depicts source data that is overlaid on top of confidence data to facilitate monitoring of the quantity of automated customer-requested executions performed for a mobile app.

The property management system 100 has automated system(s) in place to monitor when automated customer-requested functions are executed for a mobile app for rental properties. Example automated customer-requested functions include managing lists of properties “favorited” by the customers, accessing to a “frequently asked questions” section or page, viewing a dashboard of the mobile app, sending push notifications to customers, processing search requests for rental properties, scheduling rental property self-tours for the customers, etc. The property management system 100 may use one or more of the monitoring system(s) 150 to track customer-requested executions for the mobile app in an automated manner. Sometimes an error may occur that temporarily prevents one or more automated app executions from being processed. Because one or more types of executions may be requested by customers irregularly on the app throughout the day and/or week, it may be difficult for the monitoring system(s) 150 to identify when an error has occurred with the automated app executions.

The detection system 200 is configured to identify daily and/or weekly patterns among recent automated customer-requested executions for a mobile app to, in turn, detect when automated customer-requested executions have not been performed for the mobile app. The detection system 200 is configured to send a query to one of the monitoring systems 150 for source data (e.g., at block 415 of the method 400). For example, the queried source data may include data points, with each data point identifying a timestamp and a count of automated customer-requested executions that occurred at the corresponding timestamp for the mobile app. That is, the monitored metric is customer-requested executions for a mobile app (e.g., management of “favorite” properties, access to a “frequently asked questions” section or page, view of an app dashboard, customer-bound push notifications, search requests for rental properties, customer-scheduled self-tours for rental properties, etc.), and the metric value is the quantity of customer-requested executions for the mobile app that are associated with a corresponding timestamp. The query may also cap the maximum value of customer-requested executions for each data point to a predefined number to avoid outlier data from distorting the daily and/or weekly patterns of the customer-requested executions. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with occurrences of customer-requested executions performed for a mobile app is provided below in Table 9. Specifically, Table 9 includes configuration settings for generating confidence data associated with occurrences of recorded searches for rental properties on a mobile app:

TABLE 9

| Configuration | Configuration Setting |
|---|---|
| Metric Lookback | 7 |
| Changepoint Prior Scale | 0.8 |
| Seasonality Prior Scale | 140 |
| Yearly Seasonality | Auto |
| Weekly Seasonality | True |
| Daily Seasonality | True |
| Interval Width | 1.04 (incorporates a post-ML multiplier) |
| Predict Periods | 6 |
| Predict Frequency | 1 hour (“1 H”) |

The source data is then fed to the machine learning algorithm, such as a nonparametric regression model (e.g., an additive regression model), which then generates confidence data associated with occurrences of customer-requested executions for the mobile app as an output. The confidence data outputted by the machine learning algorithm includes timestamps and corresponding mean values, lower confidence intervals, and upper confidence intervals.

The detection system 200 is configured to identify a trigger index (e.g., at block 450 of the method 400). When monitoring for recent unperformed customer-requested execution(s) for a mobile app, the detection system 200 identifies the quantity of customer-requested execution(s) of the second-most-recent data entry as the trigger index. The detection system 200 also is configured identify the timestamp that corresponds with the selected trigger index (e.g., at block 455 of the method 400). To identify unperformed customer-requested execution(s) for the mobile app, the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of unperformed customer-requested execution(s) for the mobile app in response to determining that the trigger index is below the identified lower confidence interval value (e.g., at block 470 of the method 400). That is, the alert mode is a “below confidence interval (BCI)” type. In some examples, the detection system 200 is configured to monitor for recent customer-requested execution(s) at a predefined interval throughout the day and/or week to enable the detection system 200 to detect unperformed customer-requested execution(s).

Upon detecting unperformed customer-requested execution(s) for the mobile app (e.g., management of “favorite” properties, access to a “frequently asked questions” section or page, view of an app dashboard, customer-bound push notifications, search requests for rental properties, customer-scheduled self-tours for rental properties, etc.), the detection system 200 is configured to generate and transmit an alert signal to notify the remediation system 160 of the unperformed customer-requested execution(s) (e.g., at block 475 of the method 400). The remediation system 160 then is to further investigate the issue to confirm the occurrence and/or identify the cause of the automated system not performing the customer-requested execution(s).

Additionally, the detection system 200 is configured to generate the graph 1200 that depicts the comparison between the source data and the comparison data (e.g., at block 480 of the method 400). In the illustrated example, the graph 1200 depicts a plurality of data points 1210 of the source data, including a trigger index 1215. The graph 1200 also depicts comparison data 1220. In particular, the graph 1200 depicts a line 1222 (also referred to as a “mean line”) indicative of the mean values across the depicted period of time. The graph 1200 depicts a line 1224 (also referred to as an “upper confidence interval line” and an “upper confidence line”) indicative of the upper confidence interval values across the depicted period of time. The graph 1200 also depicts a line 1226 (also referred to as a “lower confidence interval line” and a “lower confidence line”) indicative of the lower confidence interval values across the depicted period of time.

Turning to FIG. 13, an example graph 1300 generated by the processor(s) 210 depicts source data that is overlaid on top of confidence data to facilitate monitoring of the quantity of artificial intelligence (AI) chatbot messages sent to customers.

The property management system 100 has automated system(s) in place to monitor when automated chatbot messages are sent to customers searching for rental properties. The property management system 100 may use one or more of the monitoring system(s) 150 to track, in an automated manner, when automated chatbot messages are sent to customers. Sometimes an error may occur that temporarily prevents one or more chatbot messages from being sent. Because chatbot messages may be sent to customers irregularly throughout the day and/or week, it may be difficult for the monitoring system(s) 150 to identify when an error has occurred with the automated chatbot messaging.

The detection system 200 is configured to identify daily and/or weekly patterns among recent automated chatbot messages to, in turn, detect when automated chatbot messages have not been performed. The detection system 200 is configured to send a query to one of the monitoring systems 150 for source data (e.g., at block 415 of the method 400). For example, the queried source data may include data points, with each data point identifying a timestamp and a count of chatbot messages sent at the corresponding timestamp. That is, the monitored metric is chatbot messages, and the metric value is the quantity of chatbot messages sent with a corresponding timestamp. The query may also cap the maximum value of chatbot messages for each data point to a predefined number to avoid outlier data from distorting the daily and/or weekly patterns of the chatbot messages. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with chatbot responses is provided below in Table 10:

TABLE 10

| Configuration | Configuration Setting |
|---|---|
| Metric Lookback | 10 |
| Changepoint Prior Scale | 0.4 |
| Seasonality Prior Scale | 20 |
| Yearly Seasonality | False |
| Weekly Seasonality | True |
| Daily Seasonality | True |
| Interval Width | 1.01 (incorporates a post-ML multiplier) |
| Predict Periods | 1 |
| Predict Frequency | 1 hour (“1 H”) |

The source data is then fed to the machine learning algorithm, such as a nonparametric regression model (e.g., an additive regression model), which then generates confidence data associated with occurrences of sent chatbot message(s) as an output. The confidence data outputted by the machine learning algorithm includes timestamps and corresponding mean values, lower confidence intervals, and upper confidence intervals.

The detection system 200 is configured to identify a trigger index (e.g., at block 450 of the method 400). When monitoring for recent unsent chatbot message(s), the detection system 200 identifies the quantity of chatbot message(s) of the second-most-recent data entry as the trigger index. The detection system 200 also is configured identify the timestamp that corresponds with the selected trigger index (e.g., at block 455 of the method 400). To identify unsent chatbot message(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of unsent chatbot message(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent chatbot message(s) at a predefined interval throughout the day and/or week to enable the detection system 200 to detect unsent chatbot message(s).

Upon detecting unsent chatbot message(s), the detection system 200 is configured to generate and transmit an alert signal to notify the remediation system 160 of the unsent chatbot message(s) (e.g., at block 475 of the method 400). The remediation system 160 then is to further investigate the issue to confirm the occurrence and/or identify the cause of the automated system not sending unsent chatbot message(s).

Additionally, the detection system 200 is configured to generate the graph 1300 that depicts the comparison between the source data and the comparison data (e.g., at block 480 of the method 400). In the illustrated example, the graph 1300 depicts a plurality of data points 1310 of the source data, including a trigger index 1315. The graph 1300 also depicts comparison data 1320. In particular, the graph 1300 depicts a line 1322 (also referred to as a “mean line”) indicative of the mean values across the depicted period of time. The graph 1300 depicts a line 1324 (also referred to as an “upper confidence interval line” and an “upper confidence line”) indicative of the upper confidence interval values across the depicted period of time. The graph 1300 also depicts a line 1326 (also referred to as a “lower confidence interval line” and a “lower confidence line”) indicative of the lower confidence interval values across the depicted period of time.

Turning to FIG. 14, an example graph 1400 generated by the processor(s) 210 depicts source data that is overlaid on top of confidence data to facilitate monitoring of the quantity of successful customer authentication executions.

The property management system 100 has automated system(s) in place to monitor when automated functions are executed for user authentications. Example user authentications include authentications for signing up, signing into a mobile app, signing into a website, token refreshes for extended user sessions, etc. The property management system 100 may use one or more of the monitoring system(s) 150 to track automated functions for user authentications in an automated manner. Sometimes an error may occur that temporarily prevents one or more automated functions from being executed. Because one or more types of user authentications may be executed irregularly throughout the day and/or week, it may be difficult for the monitoring system(s) 150 to identify when an error has occurred with the automated app executions.

The detection system 200 is configured to identify daily and/or weekly patterns among recent user authentications to, in turn, detect when user authentications have not been performed. The detection system 200 is configured to send a query to one of the monitoring systems 150 for source data (e.g., at block 415 of the method 400). For example, the queried source data may include data points, with each data point identifying a timestamp and a count of user authentications that occurred at the corresponding timestamp for the mobile app. That is, the monitored metric is user authentications (e.g., signups, mobile app sign-ins, website sign-ins, token refreshes for extended user sessions, etc.), and the metric value is the quantity of performed user authentications that are associated with a corresponding timestamp. The query may also cap the maximum value of executed user authentications for each data point to a predefined number to avoid outlier data from distorting the daily and/or weekly patterns of the user authentications. The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with occurrences of user authentications is provided below in Table 11. Specifically, Table 11 includes configuration settings for generating confidence data associated with occurrences of successful sign-ins for a mobile app for rental properties:

TABLE 11

| Configuration | Configuration Setting |
|---|---|
| Metric Lookback | 7 |
| Changepoint Prior Scale | 0.8 |
| Seasonality Prior Scale | 140 |
| Yearly Seasonality | Auto |
| Weekly Seasonality | True |
| Daily Seasonality | True |
| Interval Width | 1.03 (incorporates a post-ML multiplier) |
| Predict Periods | 6 |
| Predict Frequency | 1 hour (“1 H”) |

The source data is then fed to the machine learning algorithm, such as a nonparametric regression model (e.g., an additive regression model), which then generates confidence data associated with occurrences of user authentication(s) as an output. The confidence data outputted by the machine learning algorithm includes timestamps and corresponding mean values, lower confidence intervals, and upper confidence intervals.

The detection system 200 is configured to identify a trigger index (e.g., at block 450 of the method 400). When monitoring for recent unperformed user authentication(s), the detection system 200 identifies the quantity of user authentication(s) of the second-most-recent data entry as the trigger index. The detection system 200 also is configured identify the timestamp that corresponds with the selected trigger index (e.g., at block 455 of the method 400). To identify unperformed user authentication(s), the detection system 200 is configured to identify the lower confidence interval value that corresponds with the timestamp of the trigger index (e.g., at block 460 of the method 400). The detection system 200 is then configured to compare the trigger index to the identified lower confidence interval value (e.g., at block 465 of the method 400). The detection system 200 is configured to detect an anomaly indicative of unperformed user authentication(s) in response to determining that the trigger index is below the identified lower confidence interval value (e.g., at block 470 of the method 400). That is, the alert mode is a “below confidence interval (BCI)” type. In some examples, the detection system 200 is configured to monitor for recent user authentication(s) at a predefined interval throughout the day and/or week to enable the detection system 200 to detect unperformed user authentication(s).

Upon detecting unperformed user authentication(s) (e.g., signups, mobile app sign-ins, website sign-ins, token refreshes for extended user sessions, etc.), the detection system 200 is configured to generate and transmit an alert signal to notify the remediation system 160 of the unperformed user authentication(s) (e.g., at block 475 of the method 400). The remediation system 160 then is to further investigate the issue to confirm the occurrence and/or identify the cause of the automated system not performing user authentication(s).

Additionally, the detection system 200 is configured to generate the graph 1400 that depicts the comparison between the source data and the comparison data (e.g., at block 480 of the method 400). In the illustrated example, the graph 1400 depicts a plurality of data points 1410 of the source data, including a trigger index 1415. The graph 1400 also depicts comparison data 1420. In particular, the graph 1400 depicts a line 1422 (also referred to as a “mean line”) indicative of the mean values across the depicted period of time. The graph 1400 depicts a line 1424 (also referred to as an “upper confidence interval line” and an “upper confidence line”) indicative of the upper confidence interval values across the depicted period of time. The graph 1400 also depicts a line 1426 (also referred to as a “lower confidence interval line” and a “lower confidence line”) indicative of the lower confidence interval values across the depicted period of time.

Turning to FIG. 15, an example graph 1500 generated by the processor(s) 210 depicts source data that is overlaid on top of confidence data to facilitate monitoring of execution times for multi-system rental processes.

The property management system 100 has automated system(s) in place to monitor the time it takes to execute rental processes that span across multiple computer systems. Example multi-system rental processes include processes for financing, lease caches, payments, marketing clouds, property information, completing service requests on rental properties, etc. The property management system 100 may use one or more of the monitoring system(s) 150 to track multi-system rental processes in an automated manner. Sometimes an error may occur that temporarily prevents one or more steps in a multi-system rental process from being processed. Because one or more steps may be performed irregularly for various multi-system rental processes throughout the day and/or week, it may be difficult for the monitoring system(s) 150 to identify when an error has occurred with the automated multi-system rental processes.

The detection system 200 is configured to identify daily and/or weekly patterns for execution times of recent automated multi-system rental processes to, in turn, detect when the automated multi-system rental processes have not been performed in a timely manner. The detection system 200 is configured to send a query to one of the monitoring systems 150 for source data (e.g., at block 415 of the method 400). For example, the queried source data may include data points, with each data point identifying a timestamp and an average execution time of multi-system rental process(es) that occurred at the corresponding timestamp. That is, the monitored metric is multi-system rental process(es) (e.g., processes for financing, lease caches, payments, marketing clouds, property information, completing service requests on rental properties, etc.), and the metric value is the average execution time of multi-system rental process(es) associated with a corresponding timestamp. The query may also cap the maximum average execution time for each data point to a predefined number to avoid outlier data from distorting the daily and/or weekly patterns of the execution time(s) of the multi-system rental process(es). The source data then may be reformatted to accommodate the machine learning algorithm (e.g., at block 420 of the method 400).

The detection system 200 also is configured to select configuration settings for the machine learning algorithm of the ML system 170 (e.g., at block 405 of the method 400). An example set of configuration settings for the machine learning algorithm to generate confidence data associated with execution time(s) of multi-system rental process(es) is provided below in Table 12. Specifically, Table 9 includes configuration settings for generating confidence data associated with execution time(s) for performing services (e.g., maintenance services) requested by customers for rental properties:

TABLE 12

| Configuration | Configuration Setting |
|---|---|
| Metric Lookback | 6 |
| Changepoint Prior Scale | 0.4 |
| Seasonality Prior Scale | 1.5 |
| Yearly Seasonality | Auto |
| Weekly Seasonality | 12 |
| Daily Seasonality | 14 |
| Interval Width | 1.15 (incorporates a post-ML multiplier) |
| Predict Periods | 4 |
| Predict Frequency | 1 hour (“1 H”) |

The source data is then fed to the machine learning algorithm, such as a nonparametric regression model (e.g., an additive regression model), which then generates confidence data associated with execution times of multi-system rental processes as an output. The confidence data outputted by the machine learning algorithm includes timestamps and corresponding mean values, lower confidence intervals, and upper confidence intervals.

The detection system 200 is configured to identify a trigger index (e.g., at block 450 of the method 400). When monitoring for extended execution time(s) of multi-system rental process(es), the detection system 200 identifies execution time(s) of the second-most-recent data entry as the trigger index. The detection system 200 also is configured identify the timestamp that corresponds with the selected trigger index (e.g., at block 455 of the method 400). To identify delayed multi-system rental execution(s), the detection system 200 is configured to identify the upper confidence interval value that corresponds with the timestamp of the trigger index (e.g., at block 460 of the method 400). The detection system 200 is then configured to compare the trigger index to the identified upper confidence interval value (e.g., at block 465 of the method 400). The detection system 200 is configured to detect an anomaly indicative of multi-system rental execution(s) that are not performed in a timely manner in response to determining that the trigger index is above the identified upper confidence interval value (e.g., at block 470 of the method 400). That is, the alert mode is an “upper confidence interval (BCI)” type. In some examples, the detection system 200 is configured to monitor for execution time(s) of recent multi-system rental process(es) at a predefined interval throughout the day and/or week to enable the detection system 200 to detect extended execution time(s) of multi-system rental process(es).

Upon detecting extended execution time(s) of multi-system rental process(es) (e.g., delays in process flow for financing, lease cache, marketing cloud, property information, service requests, payment, etc.), the detection system 200 is configured to generate and transmit an alert signal to notify the remediation system 160 of the extended execution time(s) (e.g., at block 475 of the method 400). The remediation system 160 then is to further investigate the issue to confirm the occurrence and/or identify the cause of the automated system not performing the multi-system rental process(es) in a timely manner.

Additionally, the detection system 200 is configured to generate the graph 1500 that depicts the comparison between the source data and the comparison data (e.g., at block 480 of the method 400). In the illustrated example, the graph 1500 depicts a plurality of data points 1510 of the source data, including a trigger index 1515. The graph 1500 also depicts comparison data 1520. In particular, the graph 1500 depicts a line 1522 (also referred to as a “mean line”) indicative of the mean values across the depicted period of time. The graph 1500 depicts a line 1524 (also referred to as an “upper confidence interval line” and an “upper confidence line”) indicative of the upper confidence interval values across the depicted period of time. The graph 1500 also depicts a line 1526 (also referred to as a “lower confidence interval line” and a “lower confidence line”) indicative of the lower confidence interval values across the depicted period of time.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. An automated system for detecting and notifying of non-performance of customer-requested executions on a mobile app for rental property shopping, the automated system comprising:
memory configured to store instructions; and
one or more processors configured to execute the instructions to:
feed source data to a machine learning algorithm, wherein the source data includes data points for recorded quantities of the customer-requested executions at corresponding timestamps;
obtain confidence data from the machine learning algorithm, wherein the confidence data includes lower confidence interval values for the corresponding timestamps, and wherein the lower confidence interval values are indicative of lower bounds of expected quantities of the customer-requested executions on the mobile app at the corresponding timestamps;
identify a trigger index and a corresponding trigger timestamp from the source data;
identify a trigger interval value from the lower confidence interval values that corresponds with the trigger timestamp;
detect an anomaly indicative of one or more unperformed customer-requested executions in response to determining that the trigger index is less than the trigger interval value at the trigger timestamp; and
generate and transmit an alert for remediation in response to detecting the one or more unperformed customer-requested executions.

2. The automated system of claim 1, further comprising one or more databases configured to store the source data and the confidence data for subsequent retrieval.

3. The automated system of claim 1, wherein, prior to checking for the one or more unperformed customer-requested executions, the one or more processors are further configured to:
collect raw source data at a predefined interval; and
reformat the raw source data into the source data that is usable by the machine learning algorithm.

4. The automated system of claim 3, wherein, to reformat the raw source data into the source data, the one or more processors are configured to:
parse the raw source data to extract a portion with a list of entries having the recorded quantities of the customer-requested executions and the corresponding timestamps;
convert the list of entries to another data structure that is compatible with the machine learning algorithm;
rename columns with the recorded quantities of the customer-requested executions and the corresponding timestamps to be in accordance with a naming convention of the machine learning algorithm; and
reformat the timestamps to be in a predefined datetime format.

5. The automated system of claim 1, wherein the one or more processors are configured to generate and transmit a graph that overlays each of the data points of the source data for the recorded quantities of the customer-requested executions onto the confidence data.

6. The automated system of claim 1, wherein the trigger index is a second-to-last entry of the source data.

7. The automated system of claim 1, wherein the expected quantities of the customer-requested executions are to fluctuate seasonally, and wherein the confidence data is fit for daily seasonality and weekly seasonality associated with performance of the customer-requested executions on the mobile app to facilitate detection of the anomaly during different seasons.

8. The automated system of claim 1, wherein the machine learning algorithm includes a nonparametric regression model.

9. The automated system of claim 8, wherein the nonparametric regression model is a additive regression model.

10. The automated system of claim 1, wherein the confidence interval data further includes a mean value and an upper confidence interval value for each of the timestamps.

11. An automated system for detecting and notifying of non-performance of artificial intelligence (AI) chatbot messages that are programmed to be sent automatically in response to receiving inquiries from customers shopping for rental properties, the automated system comprising:
memory configured to store instructions; and
one or more processors configured to execute the instructions to:
feed source data to a machine learning algorithm, wherein the source data includes data points for recorded quantities of the AI chatbot messages sent at corresponding timestamps;
obtain confidence data from the machine learning algorithm, wherein the confidence data includes lower confidence interval values for the corresponding timestamps, and wherein the lower confidence interval values are indicative of lower bounds of expected quantities of the AI chatbot messages at the corresponding timestamps;
identify a trigger index and a corresponding trigger timestamp from the source data;
identify a trigger interval value from the lower confidence interval values that corresponds with the trigger timestamp;
detect an anomaly indicative of one or more unperformed chatbot messages in response to determining that the trigger index is less than the trigger interval value at the trigger timestamp; and
generate and transmit an alert for remediation in response to detecting the one or more unperformed chatbot messages.

12. The automated system of claim 11, further comprising one or more databases configured to store the source data and the confidence data for subsequent retrieval.

13. The automated system of claim 11, wherein, prior to checking for the one or more unperformed chatbot messages, the one or more processors are further configured to:
collect raw source data at a predefined interval; and
reformat the raw source data into the source data that is usable by the machine learning algorithm.

14. The automated system of claim 13, wherein, to reformat the raw source data into the source data, the one or more processors are configured to:
parse the raw source data to extract a portion with a list of entries having the recorded quantities of the AI chatbot messages and the corresponding timestamps;
convert the list of entries to another data structure that is compatible with the machine learning algorithm;
rename columns with the recorded quantities of the AI chatbot messages and the corresponding timestamps to be in accordance with a naming convention of the machine learning algorithm; and
reformat the timestamps to be in a predefined datetime format.

15. The automated system of claim 11, wherein the one or more processors are configured to generate and transmit a graph that overlays each of the data points of the source data for the recorded quantities of the AI chatbot messages onto the confidence data.

16. The automated system of claim 11, wherein the trigger index is a second-to-last entry of the source data.

17. The automated system of claim 11, wherein the expected quantities of the AI chatbot messages are to fluctuate seasonally, and wherein the confidence data is fit for weekly seasonality and yearly seasonality associated with performance of the AI chatbot messages to facilitate detection of the anomaly during different seasons.

18. The automated system of claim 11, wherein the machine learning algorithm includes a nonparametric regression model.

19. The automated system of claim 18, wherein the nonparametric regression model is a additive regression model.

20. The automated system of claim 11, wherein the confidence interval data further includes a mean value and upper confidence interval value for each of the timestamps.
